(19) United States
(12) Patent Application Publication
(10) Pub. No.: US 2009/0104551 A1
(43) Pub. Date: Apr. 23, 2009

(54) ELECTROPHOTOGRAPHIC PHOTORECEPTOR, IMAGE FORMING METHOD AND IMAGE FORMING

(75) Inventors: Tomoko SAKIMURA, Tokyo (JP); Toyoko SHIBATA, Kanagawa (JP); Tomoo SAKIMURA, Tokyo (JP); Takeshi ISHIDA, Tokyo (JP); Shinichi HAMAGUCHI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/248,142

(22) Filed: Oct. 9, 2008

(30) Foreign Application Priority Data
Oct. 17, 2007 (JP) 2007269869

(51) Int. Cl. G03G 17/04; G03G 15/02

(52) U.S. Cl. 430/32; 430/58.8; 430/58.75; 430/58.5

(57) ABSTRACT

Disclosed is an electrophotographic photoreceptor comprising on an electrically conductive support, a charge generation layer and a charge transport layer, wherein the charge transport layer comprises a charge transport material represented by formula (1) and exhibits a transmittance at 370 nm of not more than 10% and a transmittance at 405 nm of not less than 70%, and the charge transport layer further comprising a compound represented by formula (2), (3) or (4).

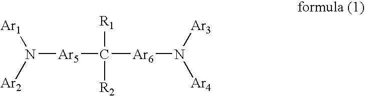

### FIELD OF THE INVENTION

The present invention relates to an electrophotographic photoreceptor used for electrophotographic image formation in the field of copiers and printers, an image forming method and an image forming apparatus by use thereof, and in particular to an electrophotographic photoreceptor suitable for semiconductor lasers exhibiting an emission wavelength of to 500 nm or light-emitting diodes exhibiting a peak wavelength of 380 to 500 nm.

### BACKGROUND OF THE INVENTION

There are currently employed electrophotographic apparatuses using lasers as a light source, typically such as laser printers. Semiconductor lasers exhibiting an emission wavelength of 780 to 800 nm are popularly employed as a laser light source. Recently, higher quality and enhanced resolution of outputted images are strongly desired and various attempts responding thereto have been made. Such attempts include, for instance, reduction of the spot diameter of a writing light. Shortening the wavelength of a writing light source theoretically enables reduction of the spot diameter, which is advantageous for enhancement of the latent image-writing density, namely, resolution. Accordingly, there has been desired development of an electrophotographic photoreceptor exhibiting enhanced sensitivity and stability and suitable for a light source of a semiconductor laser exhibiting an emission wavelength of 380 to 500 nm or a light-emitting diode exhibiting a peak wavelength of 380 to 500 nm.

Requirements for development of an electrophotographic photoreceptor corresponding to a short wavelength light source include development of a charge transport material exhibiting no absorption within the range of 380 to 500 nm of a writing light source. Currently, most charge transport materials used for an electrophotographic photoreceptor exhibit absorption of shorter wavelengths, so that the use of such charge transport materials for an electrophotographic photoreceptor exposed to a short-wavelength light source results in reduced sensitivity

To overcome such problems, there was proposed triarylamine compounds suitable for an electrophotographic photoreceptor exposed to a short-wavelength light source, as described in, for example, JP-A 2000-105475 and 2001-350282 (hereinafter, the term, JP-A refers to Japanese Patent Application Publication). However, it was proved that such compounds were weal in resistance to ultraviolet rays and deteriorated upon absorption of room fluorescent lamp light or a writing light, tendering to cause lowering of sensitivity or an increase of a residual electric-potential.

In response to such problems, there were proposed addition of aromatic hydrocarbon compounds containing a nitro group, a carbonyl group, an azo group or a hydrazone group as a quencher to a charge transport layer, as described in JP-A 2002-32457; and the use of a UV-absorbing polyarylate as a binder of a charge transport layer, as described in JP-A 5-197168, however, such techniques showed insufficient effects.

### SUMMARY OF THE INVENTION

The present invention has come into being in view of the foregoing problems. It is an object of the invention to provide an electrophotographic photoreceptor exhibiting enhanced sensitivity, improved potential stability and not causing deposition of a charge transport material in the process of production and cracking, and an image forming method and an image forming apparatus by use thereof.

The foregoing problems can be dissolved by the following constitution.

Thus, one aspect of the invention is directed to an electrophotographic photoreceptor comprising on an electrically conductive support, a charge generation layer and a charge transport layer, wherein the charge transport layer comprises a charge transport material represented by the following formula (1) and the charge transport layer also exhibits a transmittance at 370 nm of not more than 10% and a transmittance at 405 nm of not less than 70%, and the charge transport layer further comprising a compound represented by the following formula (2), (3) or (4):

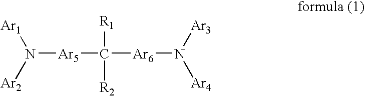

wherein Ar₁, Ar₂, Ar₃ and Ar₄ are each independently an unsubstituted or substituted aryl group, or Ar₁ and Ar₂ or Ar₃ and Ar₄ combine to form a ring; Ar₅ and A₆ are each independently an unsubstituted or substituted arylene group; R₁ and R₂ are each independently a hydrogen atom or an unsubstituted or substituted alkyl, aralkyl or aryl group, or R₁ and R₂ combine to form a ring,

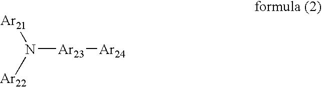

wherein Ar₂₁, A₂₂ and A₂₄ are each independently an unsubstituted or substituted aryl group; Ar₂₃ is an unsubstituted or substituted arylene group, or Ar₂₁ and Ar₂₂ or Ar₂₃ and Ar₂₄ combine to form a ring;

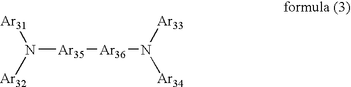

wherein Ar₃₁, Ar₃₂, Ar₃₃ and Ar₃₄ are each independently an unsubstituted or substituted aryl group, and Ar₃₅ and Ar₃₆ are each independently an unsubstituted or substituted arylene group, or Ar₃₁ and Ar₃₂, Ar₃₃ and Ar₃₄, or Ar₃₅ and Ar₃₆ combine to form a ring;

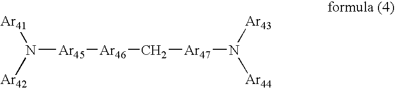

wherein Ar₄₁, Ar₄₂, A₄₃ and Ar₄₄ are each independently an unsubstituted or substituted aryl group, and Ar₄₅, A₄₆ and Ar₄₇ are each an unsubstituted or substituted arylene group, or Ar₄₁ and Ar₄₂ or A₄₃ and Ar₄₄ combine with each other to form a ring.

2. An another aspect of the invention is directed to an image forming method comprising the steps of:

subjecting an electrophotographic photoreceptor to imagewise exposure by use of a writing light source of a semiconductor laser exhibiting an emission wavelength of 380 to 500 nm or a light-emitting diode exhibiting a peak wavelength of 380 to 500 nm to form an electrostatic latent image, and

developing the electrostatic latent image to form a toner image,

wherein the electrophotographic photoreceptor is an electrophotographic photoreceptor described in the foregoing 1 or 2.

An image forming apparatus comprising an exposure device to form an electrostatic latent image by use of a writing light source of a semiconductor laser exhibiting an emission wavelength of 380 to 500 nm or a light-emitting diode exhibiting a peak wavelength of 380 to 500 nm, and a developing device to develop the electrostatic latent image to form a toner image,

wherein the electrophotographic photoreceptor is an electrophotographic photoreceptor described in the foregoing 1 or 2.

In an electrophotographic photoreceptor provided with a charge generation layer and a charge transport layer (which is, hereinafter, also denoted simply as a photoreceptor), when the surface-charged photoreceptor is exposed to light, the light is transmitted through the charge transport layer and is absorbed by a charge generation material in the charge generation layer. The charge generation material absorbs the light to generate a charge carrier. The generated charge carrier is injected into the charge transport layer and moves through the charge transport layer along an electric field formed by charging to neutralize the surface charge of the photoreceptor, whereby an electrostatic latent image is formed on the surface of the photoreceptor.

To achieve high sensitivity, therefore, a photoreceptor frequently employs a combination of a charge generation material having absorption in the range of the near-infrared region to the visible region and a charge transport material not inhibiting transmission of the absorbed light to the charge generation layer or having absorption of from a yellow light region to an ultraviolet region in which a shielding effect (or filter effect) of a writing light is lessened.

The use of a charge transport layer not absorbing writing light is essential not only for achievement of enhanced sensitivity of a photoreceptor but also for resistance to fatigue and enhancement of resolution. Thus, it was reported that when a charge transport material absorbed light, various photochemical reactions were caused and a charge transport material caused variation in sensitivity or an increase of residual potential. Generally, a part of fluorescence emitted from a charge transport material is externally scattered from the surface but its most part is trapped within a photoreceptor and repeats multiple reflection within the photosensitive layer until being absorbed by any material, resulting in bleeding of the image (lowering of resolution). It was also reported that repeated use of light in the wavelength region capable of being absorbed by the charge transport layer, resulting in lowering of charging capability and an increase of residual potential. Thus, light absorption of a charge transport material adversely affects not only sensitivity but also resolution of a latent image.

As a result of extensive study with respect to the foregoing problems, the present invention has come into being.

A charge transport layer exhibiting a transmittance at 370 nm of not more than 10% absorbs ultraviolet rays causing deterioration of a charge transport material and a transmittance at 405 nm of not less than 70% results in increased transmittance of writing light.

In the invention, the use of an additive which exhibits enhanced transmittance for writing light and absorbs only ultraviolet rays deteriorating a charge transport material can achieve enhanced potential stability without reducing sensitivity. As such an additive is effective a compound represented by formula (2), (3) or (4) which exhibits an absorption maximum at a wavelength longer than that of the compound of formula (1).

### BRIEF DESCRIPTION OF THE DRAWINGS

FIG. 1 illustrates an image forming apparatus relating to the invention.

FIG. 2 illustrates a sectional view of a color image forming apparatus relating to one embodiment of the invention.

FIG. 3 illustrates a sectional view of a color image forming apparatus using a photoreceptor relating to the invention.

### DETAILED DESCRIPTION OF THE INVENTION

In the following, there will be detailed the invention.

### Compound Of Formula (1)

In the invention, a compound of the foregoing formula (1) is used as a charge transport material.

In the formula (1), Ar₁ to Ar₄ are each independently an aryl group which may be substituted, provided that Ar₁ and Ar₂, or Ar₃ and Ar₄ may combine to form a ring; Ar₅ and A₆ are each independently an arylene group which may be substituted; R₁ and R₂ are each independently a hydrogen atom or an alkyl, aralkyl or aryl group which may be substituted, provided that R₁ and R₂ may combine with each other to form a ring.

Examples of an aryl group represented by Ar₁ to Ar₄ include a phenyl group and a tolyl group. The aryl group may be substituted and examples of a substituent include an alkyl or alkoxy group having 1 to 4 carbon atoms.

The arylene group represented by Ar₅ and A₆ is preferably a phenylene group and tolylene group, and more preferably a phenylene group. The arylene group may be substituted and examples of a substituent include an alkyl or alkoxy group having 1 to 4 carbon atoms.

Examples of a ring formed by linking of Ar₁ with Ar₂ or Ar₃ with Ar₄ include a 5- or 6-membered heterocyclic ring.

Examples of an alkyl group represented by R₁ or R₂ include alkyl groups having 1 to 4 carbon atoms, such as methyl, ethyl, isopropyl, 2-methylpropyl, and n-butyl. Examples of an aralkyl include a benzyl group, and examples of an aryl group include a phenyl group and a tolyl group. Such an alkyl, aralkyl or aryl group may be substituted and examples of a substituent include an alkyl or alkoxy group having 1 to 4 carbon atoms. R₁ and R₂ may combine with each other to form a ring, preferably a saturated hydrocarbon ring having 4 to 8 carbon atoms which may be substituted, and more preferably a cyclohexane ring which may be substituted by a methyl or ethyl group.

The compound represented by formula (1) is preferably a compound represented by the following formula (5):

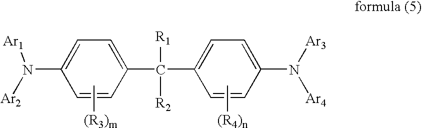

wherein Ar₁ to Ar₄ are the same as defined in Ar₁ to Ar₄ of the foregoing formula (1); and R₁ and R₂ are the same as defined in R₁ and R₂ of the foregoing formula (1); R₃ and R₄ are each independently a hydrogen atom, an alkyl group or an aryl group. An alkyl group or aryl group represented by R₃ and R₄ are each the same as defined in an alkyl group or aryl group represented by R₁ and R₂ of the foregoing formula (1); m and n are each an integer of 1 to 4.

Specific examples of a compound represented by the foregoing formula (5) are shown below.

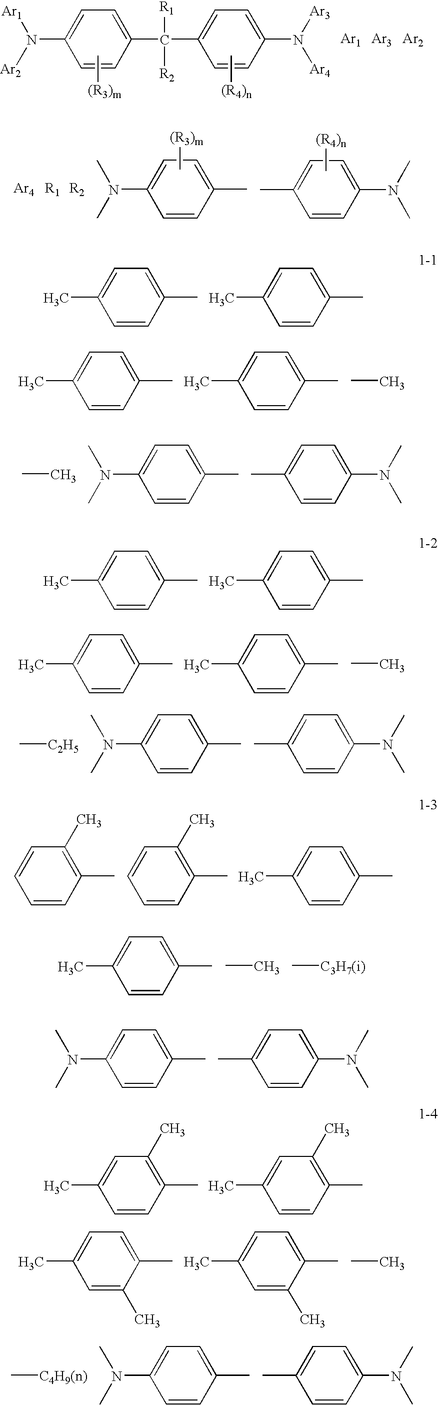

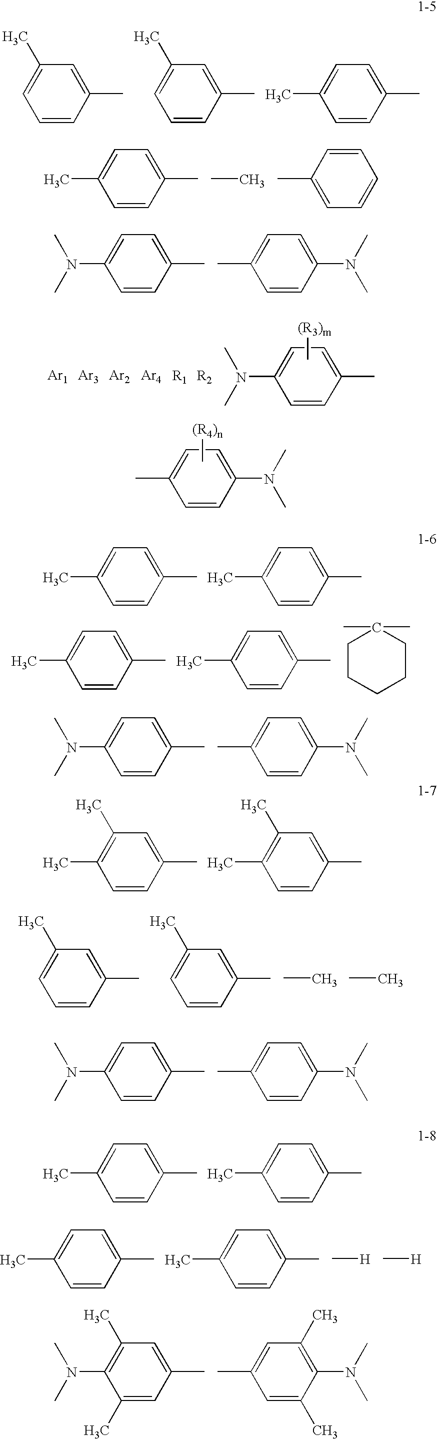

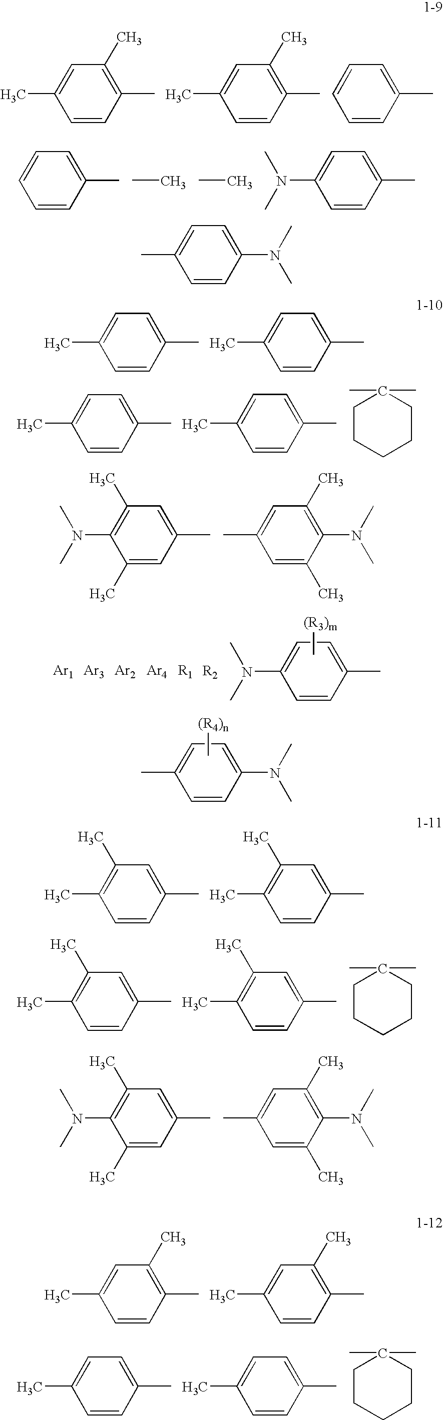

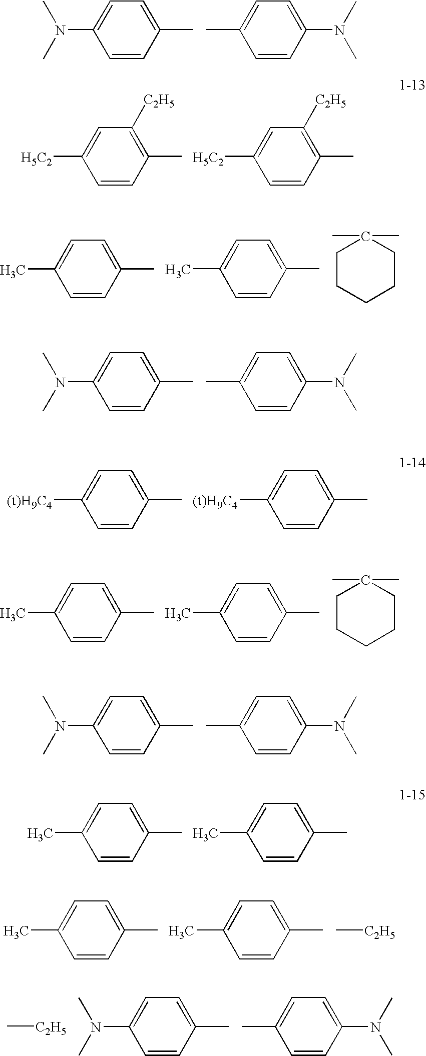

The compound represented by formula (1) can be synthesized by commonly known synthesis methods. In the following is shown a synthesis example of the foregoing compound 1-6 as one of compounds represented by formula (1).

A 2000 ml four-necked flask were fitted with a condenser, a thermometer and nitrogen-introducing tube and the interior was replaced by nitrogen. Into the flask were successively added 40 g of N,N-bis(4-methylphenyl)aniline, 20 g of cyclohexane, 140 g of acetic acid and 0.9 g of methanesulfonic acid and the mixture was reacted at 70° C. for 8 hrs. Formed solids were washed with acetone and crystallized by using tetrahydrofuran (THF) and acetone to obtain an objective compound 1-6. The thus obtained compound 1-6 was identified by known methods such as NMR or mass spectrometry.

### Compound of Formulas (2)-(4)

In the invention, to realize a charge transport layer exhibiting not more than 10% of a transmittance at 370 nm and not less than 70% of a transmittance at 405 nm, the charge transport layer further contains a compound represented by the foregoing formulas (2) to (4). These compounds, which have an absorption maximum at a little bit loner wavelength than that of a charge transport material represented by formula (1) and exhibit enhanced ultraviolet absorption effect, prevents deterioration of the charge transport material of formula (1) which is weak in resistance to ultraviolet rays. Further, it was proved that a shielding effect of writing light (filter effect) was small for a 380-500 nm writing light source.

The compound of formulas (2) to (4) has a charge transport function but when not used in combination with a charge transport material of formula (1), the transport layer cannot achieve a transmittance at 370 nm of not more than 10% and a transmittance at 405 nm of not less than 70%.

### Compound Of Formula (2)

In the formula (2), Ar₂₁, A₂₂ and A₂₄ are each independently an aryl group which may be substituted, and Ar₂₃ is an arylene group which may be substituted, provided that Ar₂₁ and Ar₂₂, or Ar₂₃ and Ar₂₄ may combine with each other to form a ring. The aryl group which may be substituted, the arylene group which may be substituted and the ring are each the same as defined in the foregoing formula (1).

Specific examples of the compound of formula (2) are shown below.

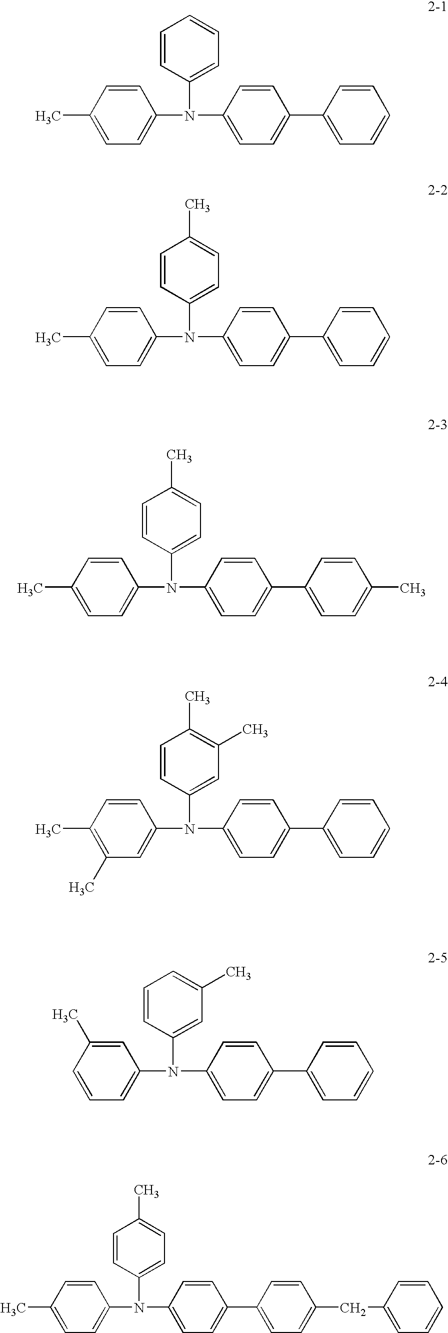

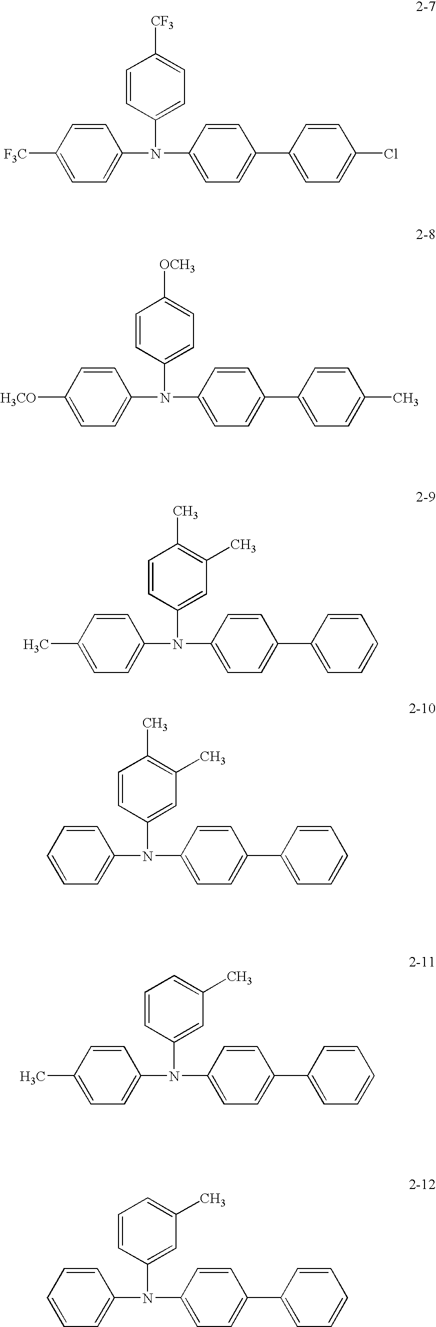

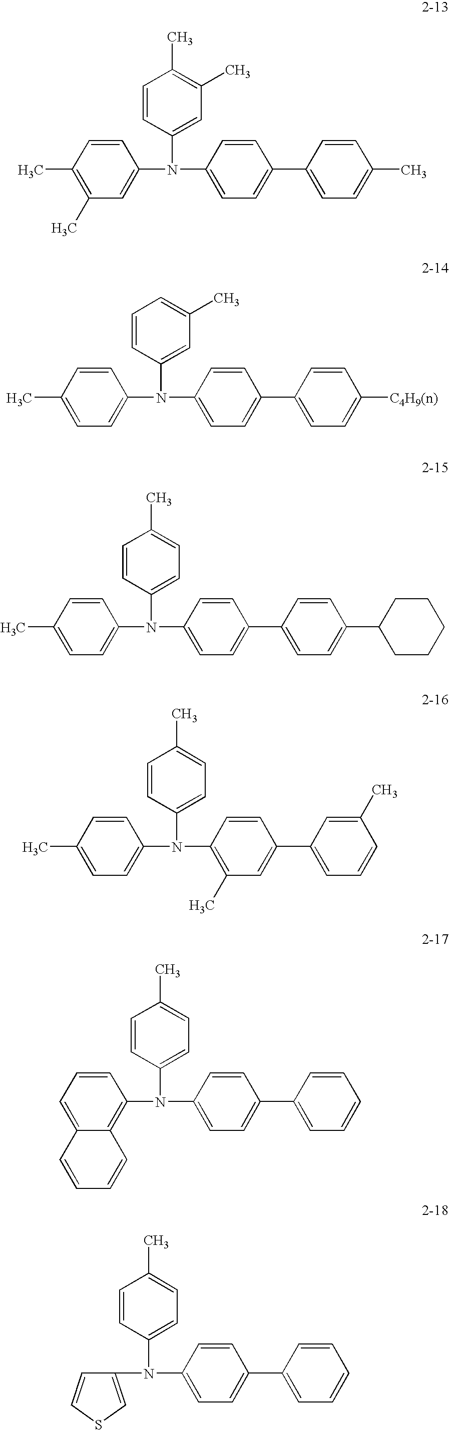

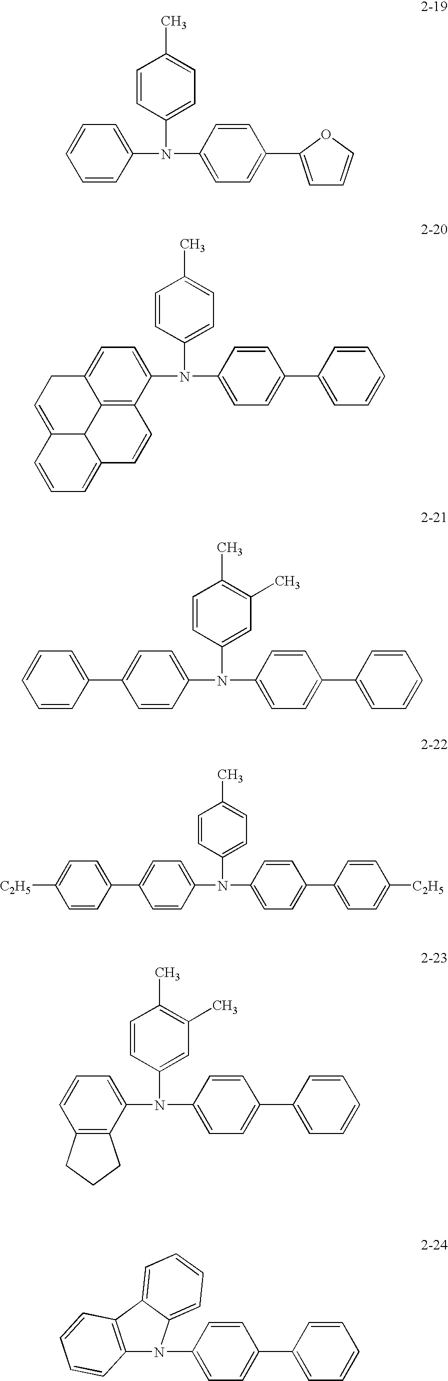

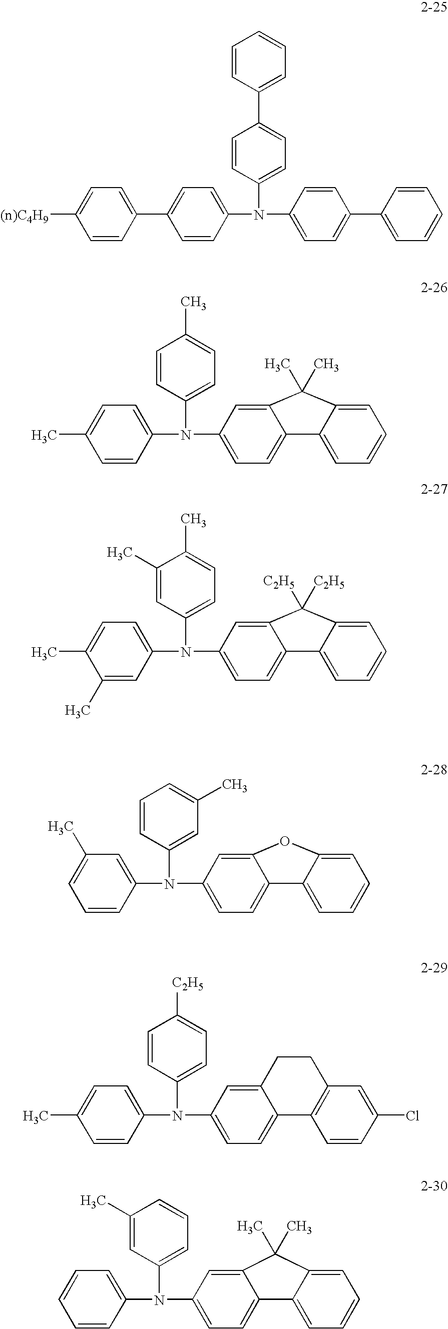

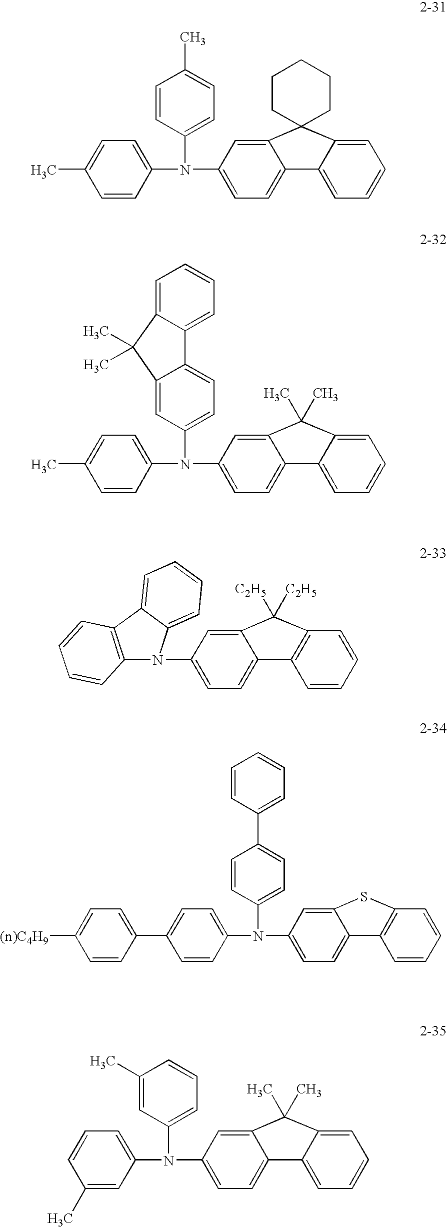

The compound represented by formula (2) can be synthesized by commonly known synthesis methods. A synthesis example of a compound 2-2 described earlier, one of compound of formula (2) is shown below.

Into a 500 ml four-necked flask were added under nitrogen 200 ml of xylene, 28.0 g of iodophenyl, 20.0 g of di(p-tolyl)amine and 10.5 g of sodium tert-butoxide and further thereto was added with stirring 10 ml of a xylene solution containing 32 mg of tri-tert-butylphosphine. Then, the mixture was heated to 120° C. and reacted over 2 to 3 hrs. After completion of reaction, 100 ml of toluene and 100 ml of water were added to perform separation. The separated organic layer was washed with water three times, dried with magnesium sulfate and condensed under reduced pressure. The thus obtained crude material was purified in silica gel chromatography to obtain targeted compound 2-2. The obtained compound 2-2 was identified by conventional methods such as NMR or mass spectrometry.

### Compound Of Formula (3)

In the formula (3), Ar₃₁ to Ar₃₄ are each independently an aryl group which may be substituted, and Ar₃₅ and Ar₃₆ are each independently an arylene group which may be substituted, provided that Ar₃₁ and Ar₃₂, Ar₃₃ and Ar₃₄, or Ar₃₅ and Ar₃₆ may combine with each other to form a ring.

The aryl group which may he substituted and the arylene group which may be substituted are each the same as defined in the foregoing formula (1).

Specific examples of the compound of formula (3) are shown below.

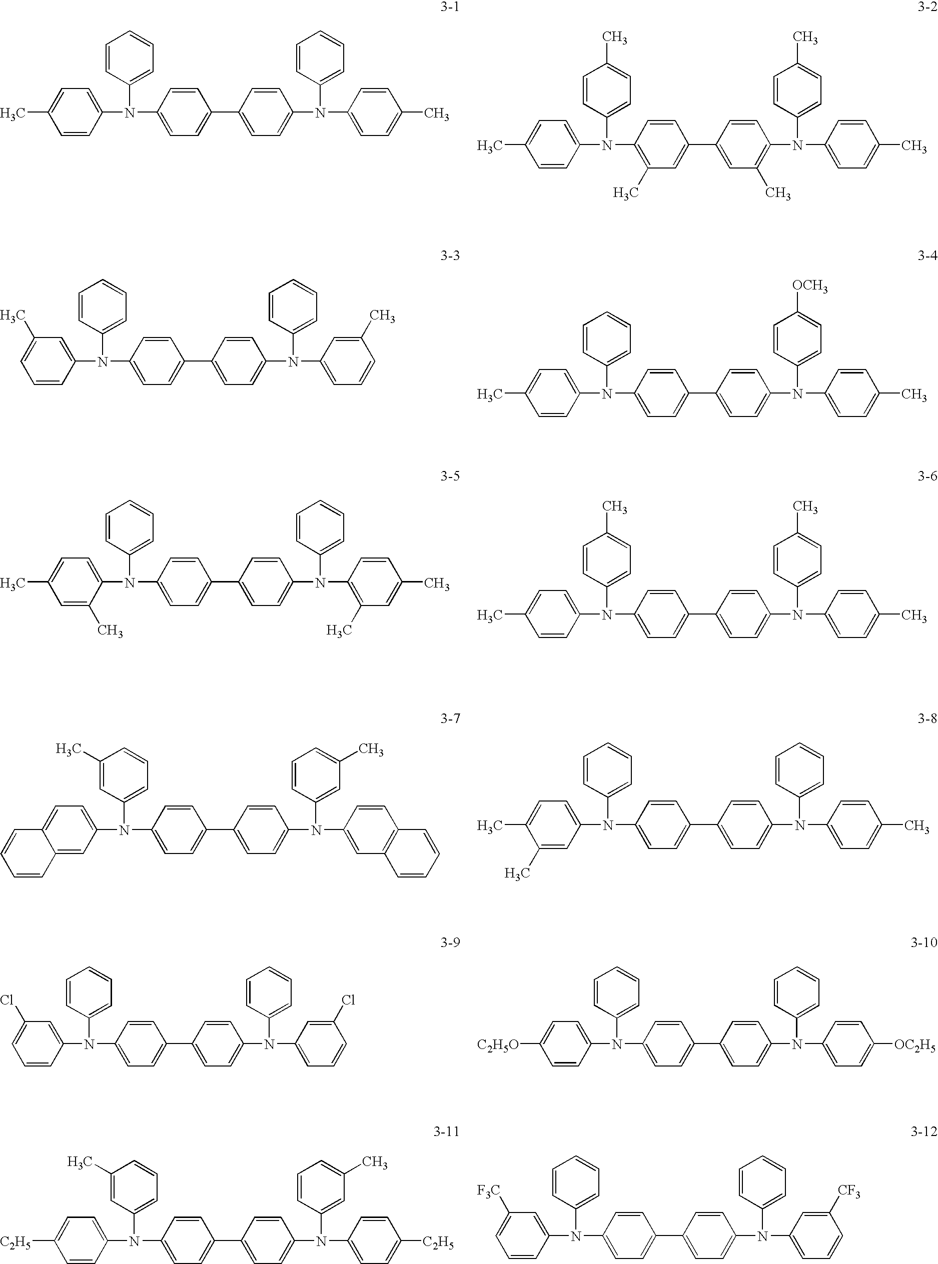

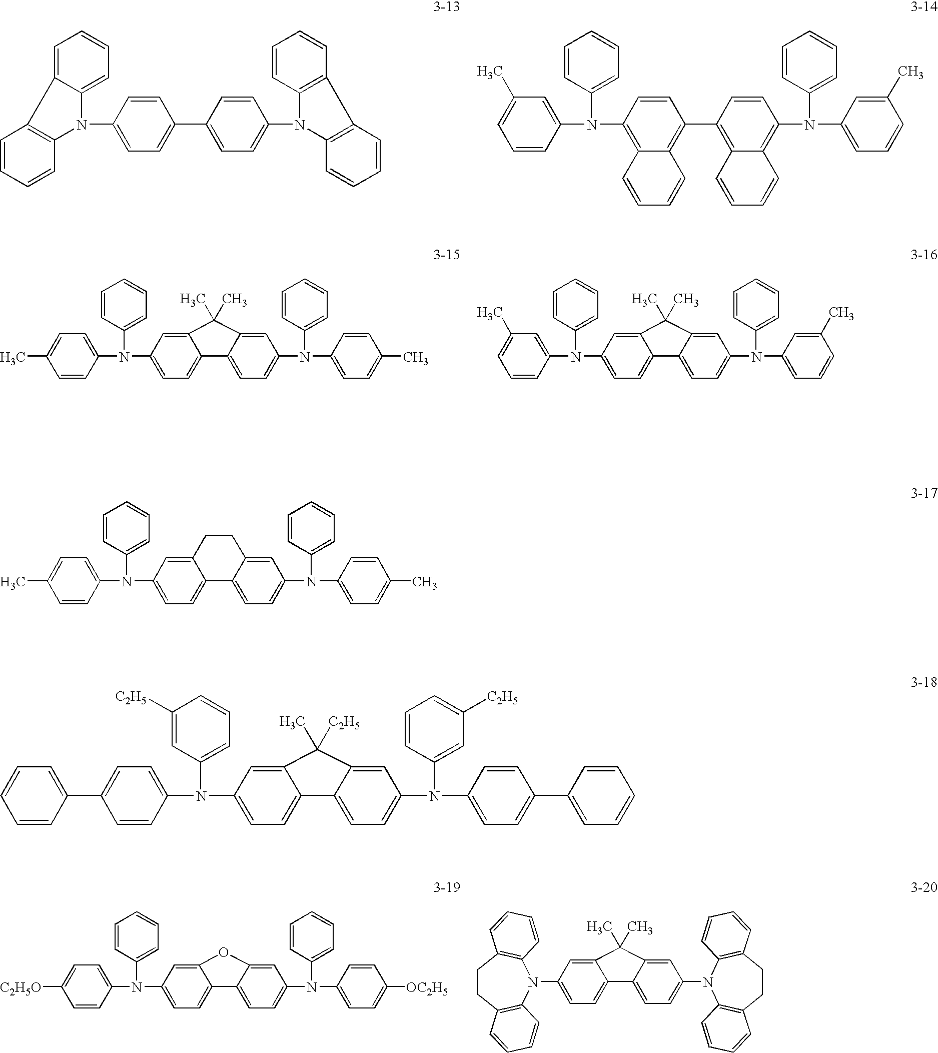

The compound represented by formula (3) can be synthesized by commonly known synthesis methods. A synthesis example of a compound 3-3 described earlier, one of compound of formula (3) is shown below.

Into a 500 ml four-necked flask were added under nitrogen were added 200 ml of xylene, 40.6 g of 4,4′-diiodobiphenyl, 40.0 g of phenyl-m-tolylamine and 21.1 g of sodium tert-butoxide and further thereto, 20 ml of a xylene solution containing 18 mg of palladium acetate and 64 mg of tri-tert-butylphosphine. Thereafter, the mixture was heated to 120° C. and reacted for 2-3 hrs. After completion of reaction, the reaction mixture was cooled and 200 ml of toluene and 200 ml of water were added thereto to perform separation. The separated organic layer was washed with 100 ml of water three times, dried on magnesium sulfate and condensed under reduced pressure. The thus obtained crude material was purified in silica gel chromatography to obtain targeted compound 3-3. The obtained compound 3-3 was identified by conventional methods such as NMR and mass spectrometry.

### Compound Of Formula (4)

In the formula (4), Ar₄₁ to Ar₄₄ are each independently an aryl group which may be substituted, and Ar₄₅ to Ar₄₇ are each an arylene group which may be substituted. Ar₄₁ and Ar₄₂ or A₄₃ and Ar₄₄ may combine with each other to form a ring.

The aryl group which may be substituted, the arylene group which may be substituted and the ring are each the same as defined in the foregoing formula (1).

Specific examples of the compound of formula (4) are shown below.

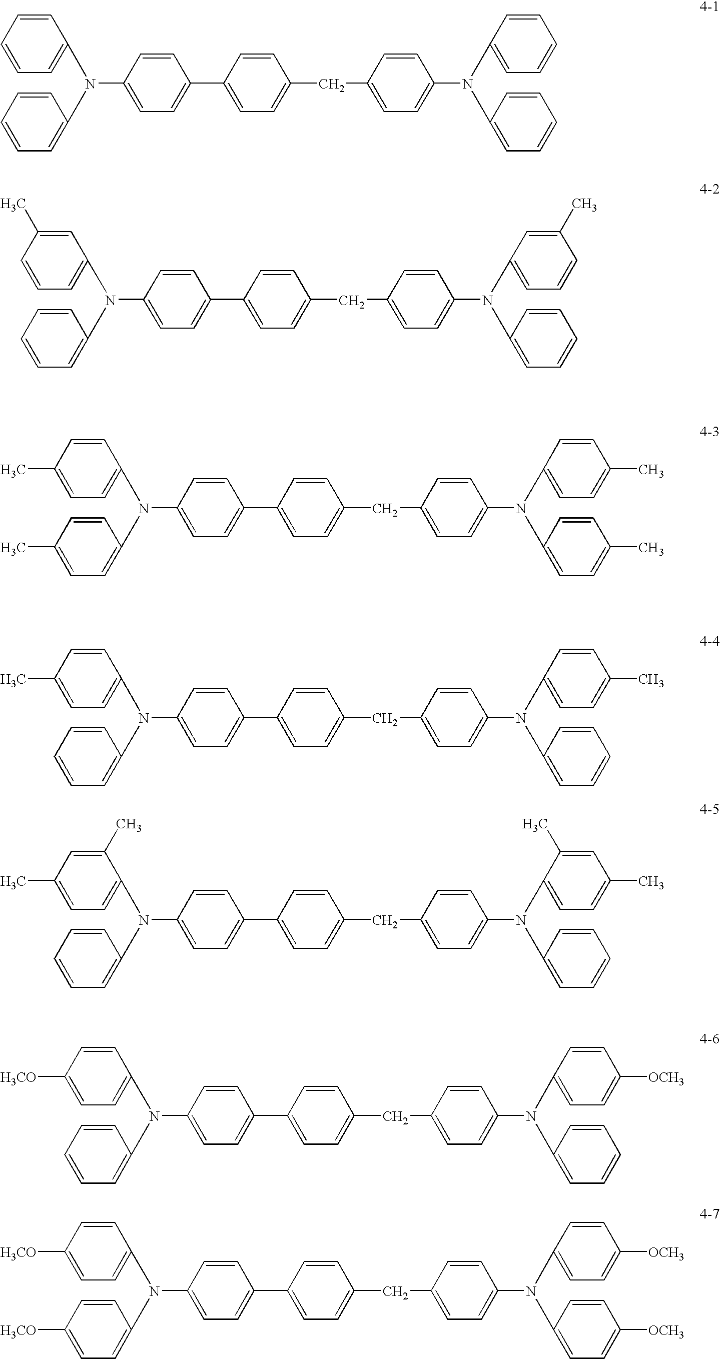

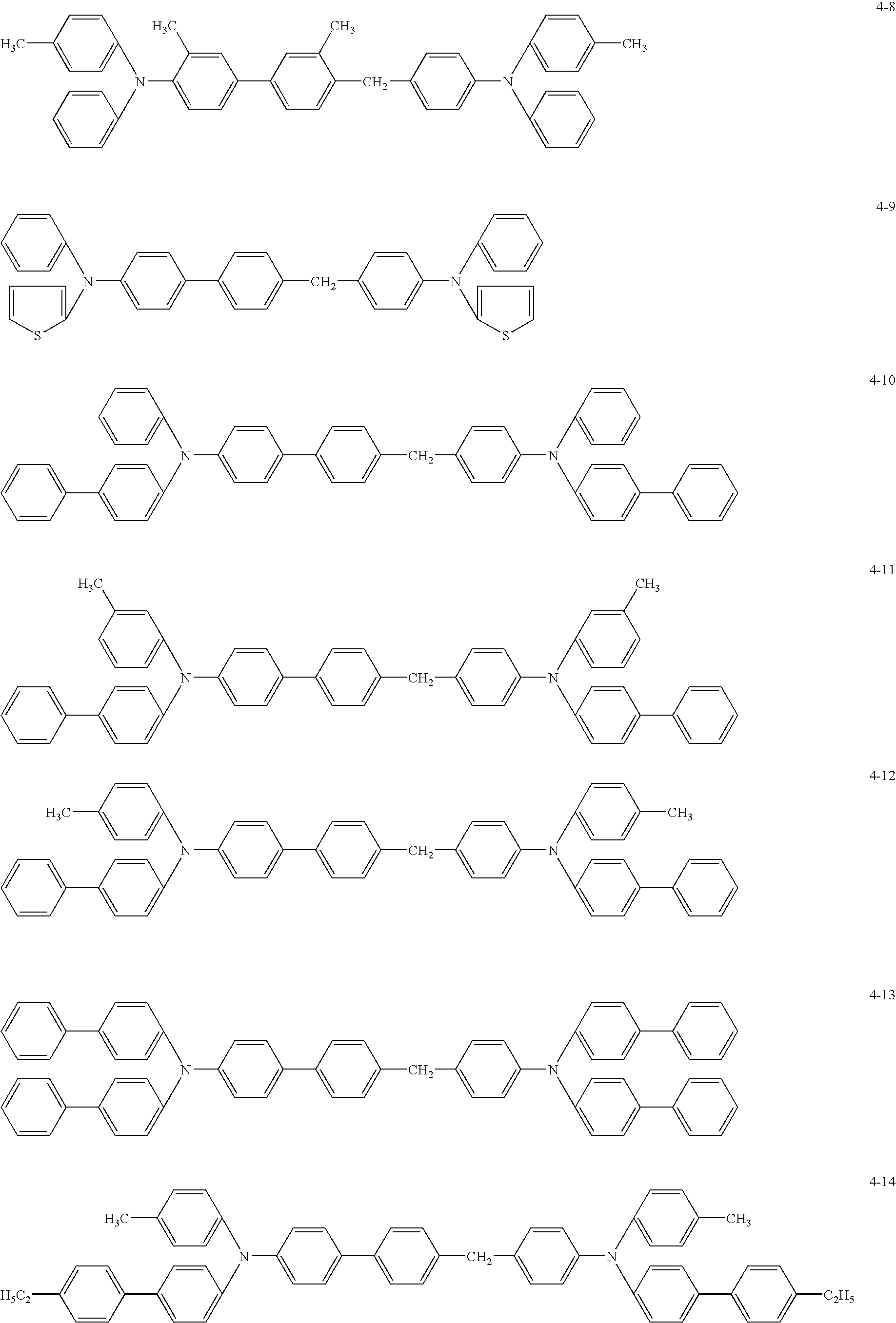

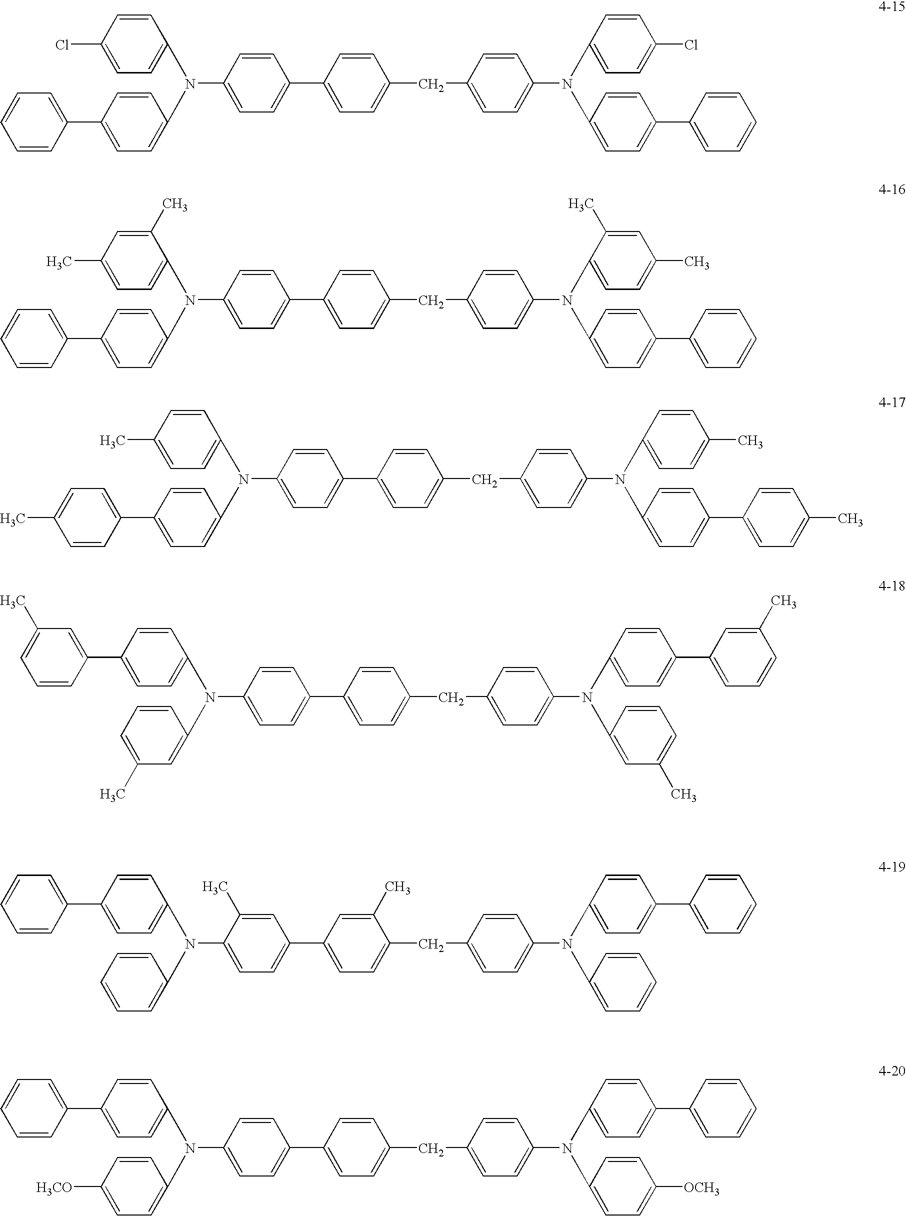

The compound represented by formula (4) can be synthesized by commonly known synthesis methods. A synthesis example of a compound 4-4 described earlier, one of compound of formula (4) is shown below.

Into a 1 liter four-necked flask fitted with a reflux condenser were added 50 g (0.10 mole) of 4-iododiphenyl-4′-p-iodobenzene, 44 g (0.24 mole) of 3-methyldiphenylamine, 35 g (0.5 mole) of potassium carbonate, 10 g (0.16 mole) of powdery copper and 400 g of nitrobenzene and reacted at 200° C. for 18 hrs. under a nitrogen gas stream. After completion of reaction, 200 g of tetrahydrofrane was added into the reaction mixture and solids were filtered. The filtrate was separated in silica gel chromatography and the separated material was recrystallized in a mixed solvent of toluene and ethanol to perform purification. The thus obtained compound 4-4 was identified in a conventional method such as NMR or mass spectrometry.

### Photoreceptor

The photoreceptor of the invention is featured in that a charge transport layer contains a charge transport material represented by the afore-described formula (1) and exhibits a transmittance at 370 nm of not more than 10% and a transmittance at 405 nm of not less than 70%. There will be described constitution of a photoreceptor containing such a charge transport material.

In the invention, a photoreceptor refers to one which is constituted of an organic compound having at least one of a charge generation function and a charge transport function, and including all of commonly known photoreceptors, such as a photoreceptor constituted of a known charge generation material or charge transport material or a photoreceptor in which a charge generation function and a charge transport function are provided by polymeric complexes.

In the invention, the constitution of a photoreceptor is not specifically limited so far as a compound of the formula (1) is contained as a charge transport material and the charge transport layer exhibits a transmittance at 370 nm of 10% or less and a transmittance at 405 nm of 70% or more. Examples thereof include constitutions as described below:

1) a constitution comprising on an electrically conductive support a photo-sensitive layer comprised of a charge generation layer and a charge transport layer;

2) a constitution comprising on a conductive support a photo-sensitive layer comprised of a charge generation layer, a first charge transport layer and a second charge transport layer;

3) a constitution comprising on a conductive support a photo-sensitive layer comprised of a single layer containing a charge generation material and a charge transport material;

4) a constitution comprising on a conductive support a photo-sensitive layer comprised of a charge transport layer and a charge generation layer;

5) a constitution comprising a protective layer on any one of the photo-sensitive layers of the foregoing 1) to 4).

The photoreceptor may be any one of the foregoing constitutions. The surface layer of a photoreceptor is a layer on which the photoreceptor is in contact with air. In cases where a single photosensitive layer is provided on a conductive support, for instance, the photosensitive layer is the surface layer, and in cases where a multiple photosensitive layers and a surface protective layer are provided on a conductive support, the surface protective layer is the uppermost surface layer. In the invention, the constitution 2) is preferred. In any one of the foregoing constitutions, the conductive support may be provided with a sublayer (or intermediate layer) prior to formation of the photosensitive layer.

The charge transport layer refers to a layer having a function of transporting a charge carrier generated in a charge generation layer upon exposure to light. Specific detection of such charge-transporting function can be confirmed by forming a charge generation layer and a charge transport layer on a conductive support and detecting photoconductivity.

Layer constitution of a photoreceptor will be described based the foregoing constitution 1).

### Conductive Support

Electrically conductive supports used in the invention may be in a sheet form or a cylindrical form but the cylindrical conductive support is preferred in design of a more compact image forming apparatus.

A cylindrical conductive support means a cylindrical support enable to endlessly achieve image formation through rotation. A cylindrical conductive support with a straightness of 0.1 mm or less and a deflection of 0.1 mm or less is preferred. A straightness or a deflection exceeding these ranges render it difficult to achieve superior image formation.

There are usable a metal drum such of as aluminum or nickel as conductive material, a plastic drum on which aluminum, tin oxide or indium oxide is deposited and a conductive material-coated paper or plastic drum. There is preferred a conductive support exhibiting a specific resistance of not less 10³ Ω·cm at ordinary temperature. An aluminum support is specifically preferred as a conductive support usable in the invention. The aluminum support may contain components such as manganese, zinc or magnesium other than aluminum as a main component.

### Intermediate Layer

In the invention, an intermediate layer is provided between a conductive support and a photosensitive layer. The intermediate layer preferably contains N-type semiconductor particles. “N-type semiconductor particles” means those in which the main charge carrier is an electron. Thus, since the main charge carrier is an electron, an intermediate layer containing the N-type semiconductor particles efficiently blocks hole-injection from the substrate and exhibits the property of being little blocking of electrons from the photosensitive layer.

Metal oxides such as titanium dioxide (TiO₂) and zinc oxide (ZnO) are preferably used as N-type semiconductor particles and titanium dioxide is more-preferred.

As N-type semiconductor particles are used fine particles exhibiting a number average primary particle size falling within the range of 3.0 to 200 nm, but preferably 5.0 to 100 nm. The number average primary particle size is a value obtained in such a manner that 100 particles are microscopically observed as primary particles by a transmission electron microscope at a magnifying power of 10,000 and measured as a Feret average diameter through image analysis. N-type semiconductor particles having a number average primary particle size of less than 3.0 nm are difficult to be homogeneously dispersed in a binder of the intermediate layer and often form aggregated particles, which act as a charge trap and cause transfer memory. On the other hand, N-type semiconductor particles having a number average primary particle size of more than 100 nm easily form protrusions on the surface of the intermediate layer and dielectric breakdown or black-spotting often occurs through these large protrusions. Further, N-type semiconductor particles having a number average primary particle size of more than 100 nm are easily deposited in a dispersion, easily forming aggregates and leading to deteriorated dot images.

Titanium dioxide particles include an anatase type, a rutile type, a brokite type and an amorphous type. Of these, the anatase type titanium dioxide pigment or the rutile type titanium dioxide enhances rectification of a charge passing through the intermediate layer or enhances movement of electrons, resulting in a stabilized charge potential and preventing an increase of residual potential and subsequent occurrence of spotting.

N-type semiconductor particles are preferably those which were previously surface-treated with a polymer comprising a methyl hydrogen siloxane unit. A polymers comprising a methyl hydrogen siloxane unit and having a molecular weight of 1000 to 20000 effectuates enhanced surface treatment, resulting in enhanced rectifying capability of N-type semiconductor particles. Accordingly, the use of such N-type semiconductor particles prevents occurrence of black spotting and is effective in optimal halftone image formation.

The polymer comprising a methyl hydrogen siloxane unit is preferably a copolymer comprising a structural unit of —[HSi(CH₃)O]— and other structural unit (other siloxane units). Of other siloxane units, a dimethylsiloxane unit, a methylethylsiloxane unit, a methylphenylsiloxane unit or diethylsiloxane unit is preferred and a dimethylsiloxane unit is specifically preferred. The content of methyl hydrogen siloxane in a copolymer is preferably 10 to 99 mol % and more preferably 20 to 90 mol %.

A methyl hydrogen siloxane copolymer may be any one of a random copolymer, a block copolymer and a graft copolymer, but a random copolymer or a block copolymer is preferred. The copolymer may be comprised of a single component or two or more components in addition to methyl hydrogen siloxane.

Other than the foregoing N-type semiconductor particles, a coating solution to form the intermediate layer used in the invention is composed of a binder resin, a dispersing solvent and the like.

The volume of N-type semiconductor particles used in the intermediate layer is preferably 0.5 to 2.0 times that of the binder resin of the intermediate layer. Such a high density of N-type semiconductor particles in the intermediate layer results in enhanced rectification and even when the layer thickness is increased, neither an increase of residual potential nor spotting occur and black spots are effectively prevented, thereby forming an organic photoreceptor exhibiting little potential variation and capable of forming superior halftone images. The intermediate layer contains N-type semiconductor particles preferably in an amount of 100 to 200 parts by volume.

The binder resin which disperses these particles and forms an intermediate layer structure is preferably a polyamide resin. Specifically, the polyamide resin as described below is preferred.

Alcohol-soluble polyamide resin is preferred as a binder of the intermediate layer. A binder of the intermediate layer of an organic photoreceptor requires superior solubility in solvent. There are known copolymer polyamide resins composed of a chemical structure having fewer carbon atoms between amide bonds, such as 6-nylon and methoxymethylated polyamide as an alcohol-soluble polyamide, however, a polyamide resin having the following chemical structure is preferable.

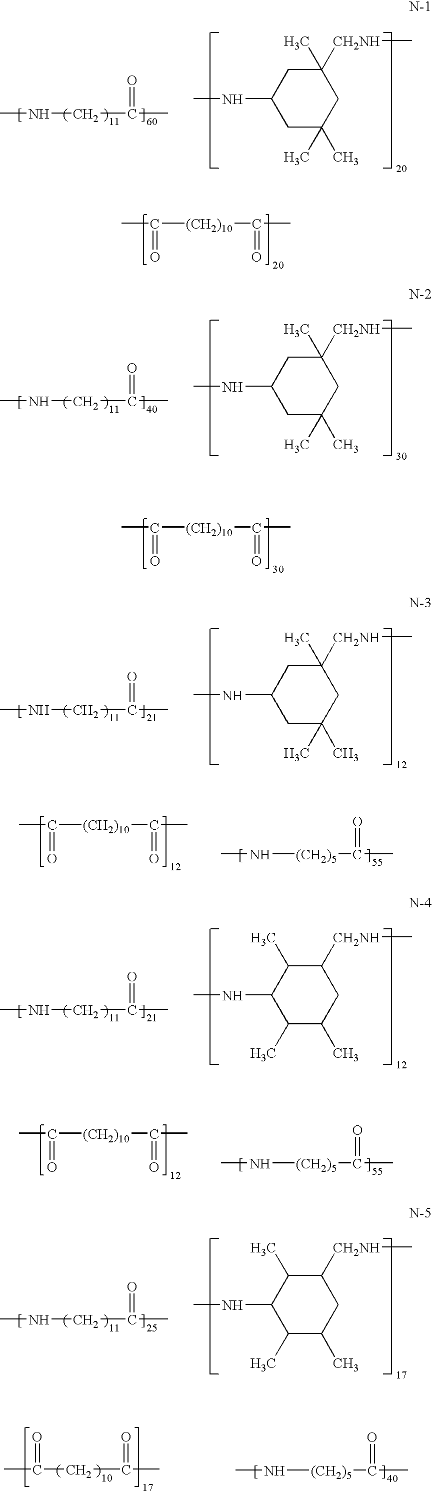

The number average molecular weight of a polyamide resin is preferably from 5,000 to 80,000, and more preferably from 10,000 to 60,000. A number average molecular weight of less than 5,000 deteriorates uniformity of the intermediate layer, resulting in insufficient advantageous effects of the invention. A number average molecular weight of more than 80,000 lowers solvent solubility of the resin, often forming aggregated resin in the intermediate layer and causing black spotting or deteriorated dot images.

The foregoing polyamide resin is commercially available, for example, Best Melt X1010 and X4685 (trade name) are available from DAICEL-DEGUSA. Co., Ltd. but can be prepared by generally known synthesis methods of polyamides.

Solvents used for dissolving the foregoing polyamide resin to prepare a coating solution are preferably alcohols having 2 to 4 carbon atoms, including, for example, ethanol, n-propyl alcohol, isopropyl alcohol, n-butanol, t-butanol and sec-butanol. These solvents preferably account for 30 to 100%, more preferably 40 to 100%, and still more preferably 50 to 100% by mass of the total solvents. Examples of an auxiliary solvent which is usable in combination with the foregoing solvents and achieves preferred effects, include methanol, benzyl alcohol, toluene, methylene chloride, cyclohexanone and tetrahydrofuran.

In the invention, the thickness of the intermediate layer is preferably from 0.3 to 10 μm, and more preferably from 0.5 to 5 μm. A thickness of less than 0.3 μm easily causes black spots, leading to deteriorated dot images. A thickness of more than 10 μm often causes an increase of residual potential, resulting in deteriorated dot images. The thickness of an intermediate layer is preferably from 0.5 to 5 μm.

The intermediate layer is preferably an insulation layer. The insulation layer refers to a layer exhibiting a volume resistance of not less than 1×10⁸ Ω·cm. In the invention, the volume resistance of an intermediate layer or a protective layer is preferably from 1'10⁸ to 1×10¹⁵ Ω·cm, more preferably from 1×10⁹ to 1×10¹⁴ Ω·cm, and still more preferably from 2×10⁹ to 1×10¹³ Ω·cm. The volume resistance can be measured, for example, as below:
Measurement condition: JIS C2318-1975
Measurement instrument; Hiresta IP (produced by Mitsubishi Yuka Co.)
Measurement probe: HRS
Applied voltage: 500 V
Measurement environment: 30±2° C., 80±5% RH.

A volume resistance of less than 1×10⁸ Ω·cm results in lowered charge blocking capability of the intermediate layer, increased black spots and deteriorated potential retention of an organic photoreceptor, accordingly, superior image quality cannot be achieved. On the other hand, a volume resistance of more than 1×10¹⁵ Ω·cm often increases residual potential, while repeating image formation, so that superior image quality cannot be achieved.

### Photosensitive Layer

In the photoreceptor of the invention, the function of the photosensitive layer is separated to a charge generation layer (CGL) and a charge transfer layer (CTL). The thus separated constitution can restrain an increase of residual potential along with repeated use and can easily control other electrophotographic characters according to the object. In a negative-charged photoreceptor, it is preferred that a charge generation layer (CGL) is formed on an intermediate later and further thereon a charge transport layer (CTL) is formed.

There will be described below photosensitive layer constitution of a function-separated negative-charged photoreceptor.

### Charge Generation Layer

The photoreceptor of the invention preferably employs a charge generation material (CGM) exhibiting a high-sensitivity characteristic in the wavelength region of 380 to 500 nm. Preferred examples of such a charge generation material include a phthalocyanine compound, a polycyclic quinone compound, a perylene compound and an azo compound. These pigments may be used in combination. Specific examples of a preferred pigment compound used in the invention are shown below.

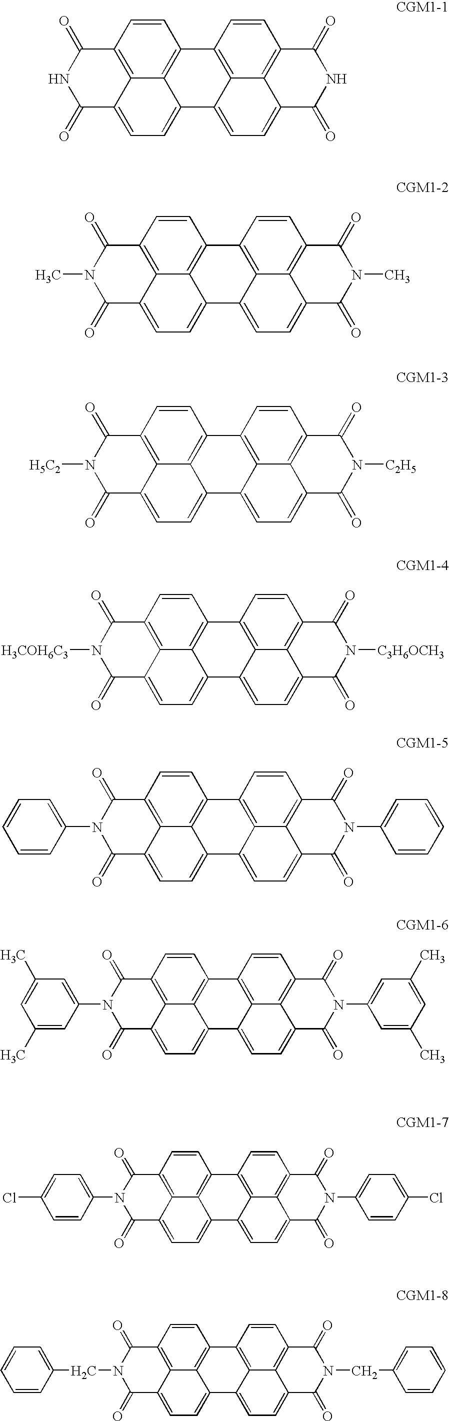

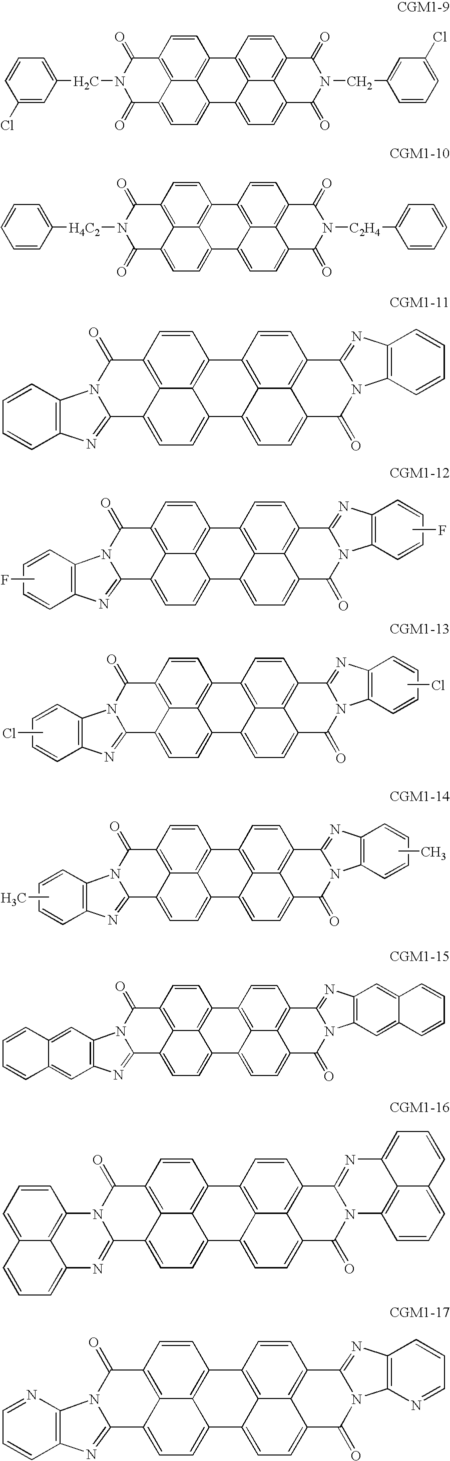

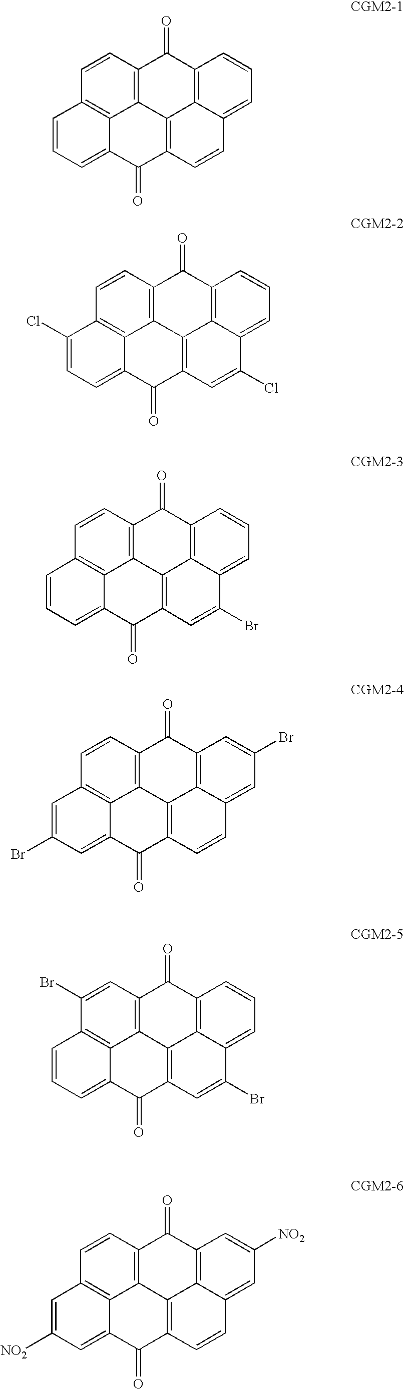

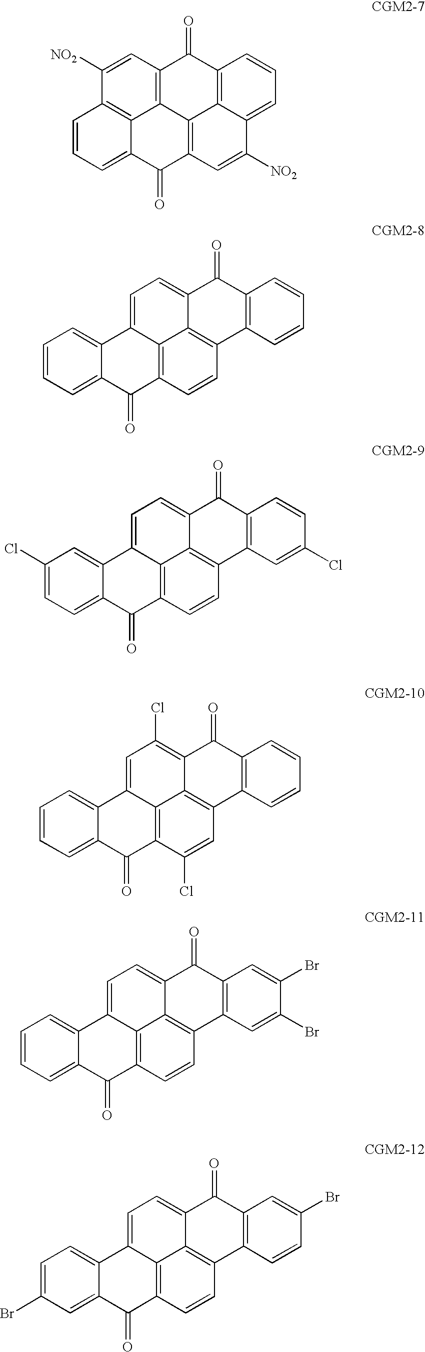

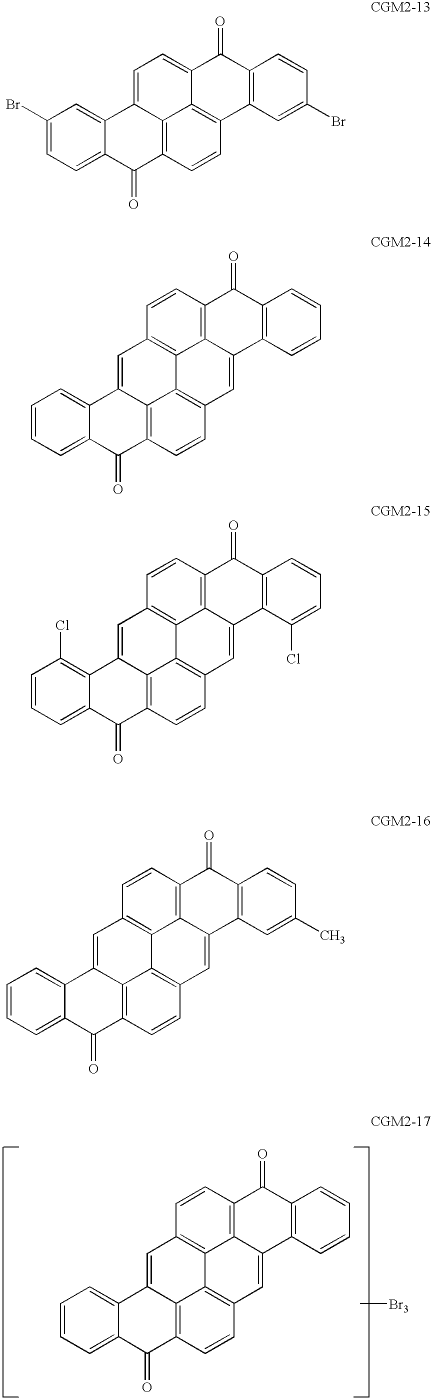

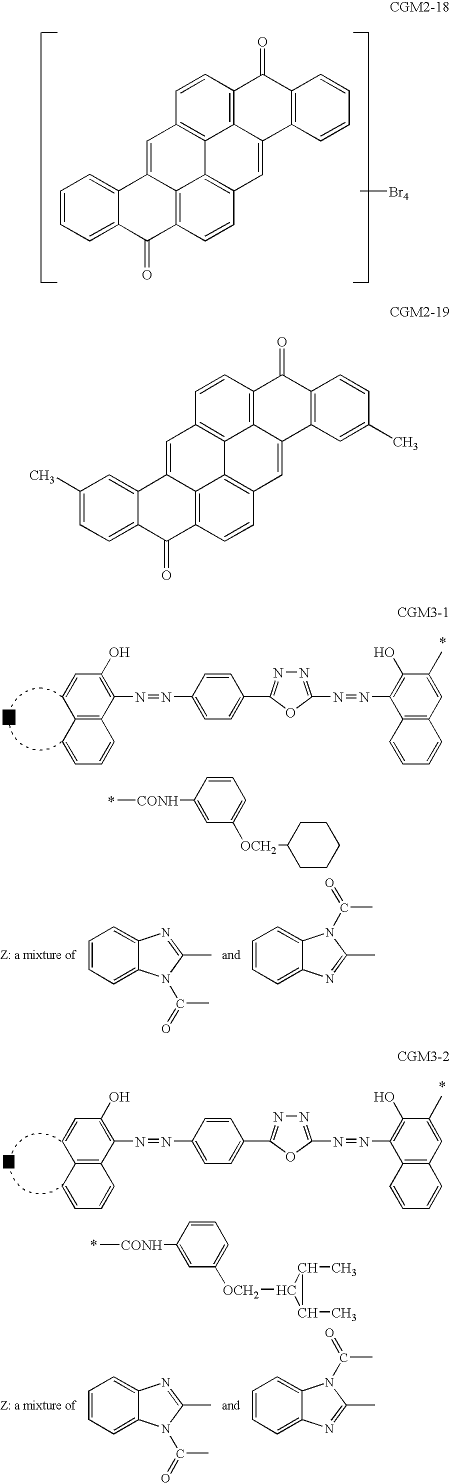

In the invention, a phthalocyanine compound, a polycyclic quinone compound and an azo compound are preferred, and a polycyclic quinone compound is more preferred.

There are usable commonly known binders as a dispersing medium for CGM in the charge generation layer. Preferred examples of such a binder include a formal resin, butyral resin, a silicone resin, silicone-modified butyral resin and a phenoxy resin The ratio thereof is preferably 20-600 parts by mass of charge generation material to 100 parts by mass of binder resin. The use of such a resin can minimize an increase of residual potential along with repeated use.

### Charge Transport Layer

A charge transport layer contains a charge transport material (CTM) and a binder resin to disperse CTM and to form a film. In addition, there may optionally be contained other materials, such as inorganic microparticles described earlier and an antioxidant.

A charge transport material is usually dissolved in an appropriate binder to form a layer. Resins used for the charge transport layer (CTL) of the invention include, for example, polystyrene, an acryl resin, a vinyl chloride resin, a vinyl acetate resin, a polyvinyl butyral resin, an epoxy resin, a polyurethane resin, a phenol resin, a polyester resin. an alkyd resins a polycarbonate resin, silicone resin, a melamine resin and their copolymer resin. In addition to these insulating resins is cited polymer organic semiconductors such as poly-N-vinylcarbazole. Of these resins, a polycarbonate resin is preferred in terms of lessened water-absorptivity, enhanced dispersibility of CTM and superior electrophotographic characteristics.

The ratio thereof is preferably 10 to 200 parts by mass of a charge transport material to 100 parts by mass of a binder resin.

The total thickness of a charge transport layer is preferably 10 to 25 μm. A total layer thickness of less than 10 μm is difficult to secure sufficient latent image potential in development, resulting in reduced image density and deteriorated dot reproduction. A thickness of more than 25 μm results in increased diffusion of charge carriers (diffusion of charge carriers generated in the charge generation layer), leading to deteriorated dot reproduction. The thickness of the charge transport layer as a surface layer is preferably from 1.0 to 8.0 μm.

Solvents and dispersing media used for an intermediate layer, a charge generation layer or a charge transport layer include, for example, n-butylamine, diethylamine, ethylenediamine, isopropanolamine, triethanolamine, triethylene diamine, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolan, dioxane, methanol, ethanol, butanol, isopropanol, ethyl acetate, butyl acetate, dimethylsulfoxide and methyl cellosolve. The invention is not limited to these, but 1,2-dichloromethane, 1,2-dichloroethane and methyl ethyl ketone are preferred. These solvents may be used singly or in combination as mixed solvents.

Usable coating methods for production of photoreceptors include, for example, immersion coating and spray coating as well as slide hopper coating. It is specifically preferred to use a circular slide hopper type coater to form the surface layer.

Of coating solution-supplying type coaters, a coating method using a slide hopper type coater is most suitable for use of a coating solution of a low-boiling solvent dispersion. Coating by a circular slide hopper type coater is preferred for a cylindrical photoreceptor, as described in JP-A 58-189061.

In regard to the above coating by a circular slide hopper type coater is preferred for a cylindrical photoreceptor, in which the end of the slide surface and the substrate are disposed at a gap (approximately from 2 μm to 2 mm) so that coating is performed without damaging the substrate, where even in the case of multiple layer formation differing in kinds of layers, coating is feasible without damaging the coated layer. Further, even in multiple layer formation differing in the nature of layers but soluble in an identical solvent, residence time in the solvent is much shorter than a dip-coating method so that coating is performed without eluting a lower layer component into an upper layer or to a coating bath and also without deteriorating dispersibility of the inorganic particles.

The photoreceptor of the invention preferably contains an antioxidant in its surface layer. The surface layer is easily oxidized by an active gas such as NOₓ or by ozone produced when electrostatically charging the photoreceptor. Co-existence of an antioxidant prevents image-blurring. Such an antioxidant is a substance which exhibits a property of preventing or inhibiting the adverse action of oxygen under conditions such as light, heat or discharge with respect to an auto-oxidative material typically existing in the interior or on the surface of the photoreceptor. The following compounds are typically cited.

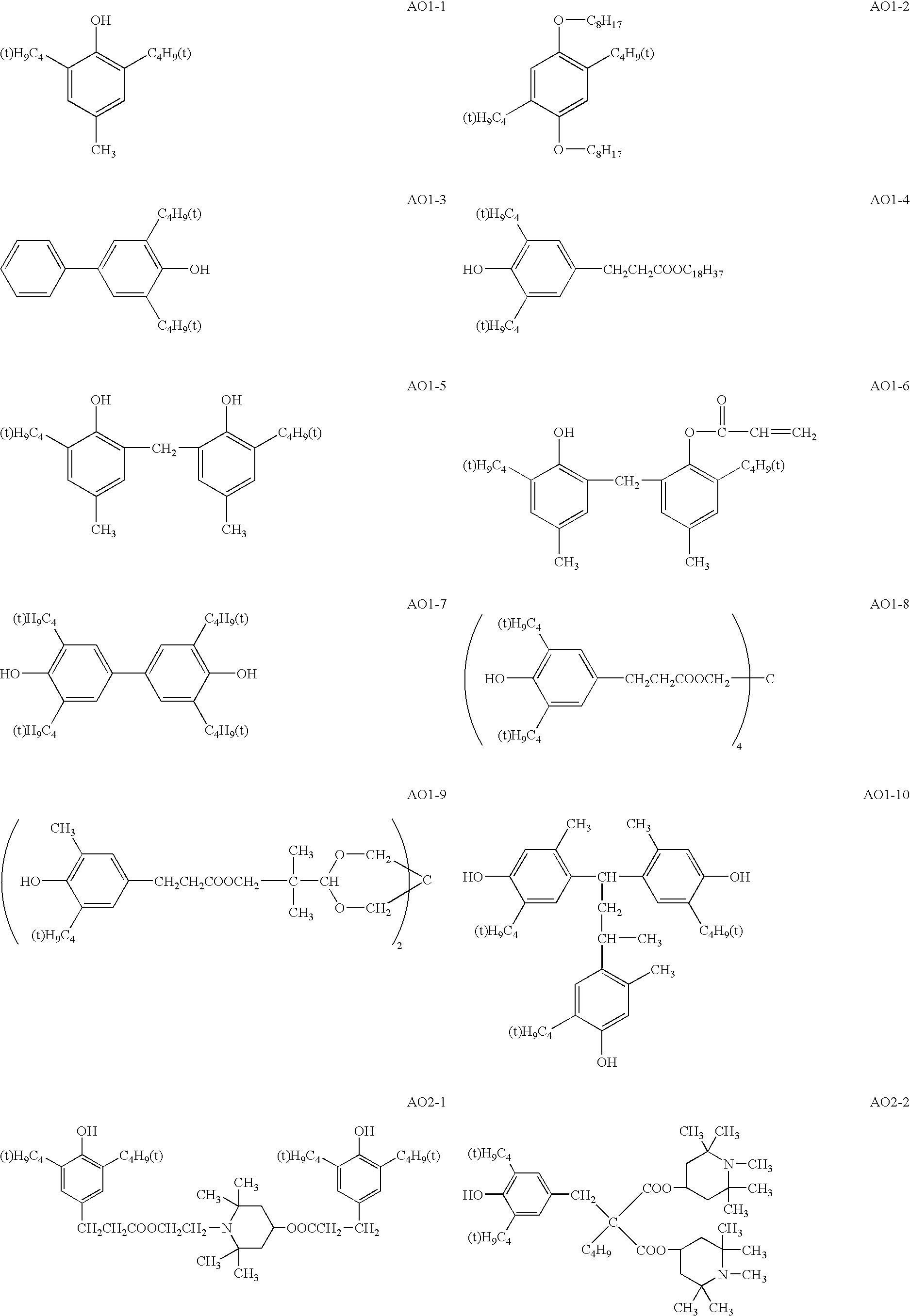

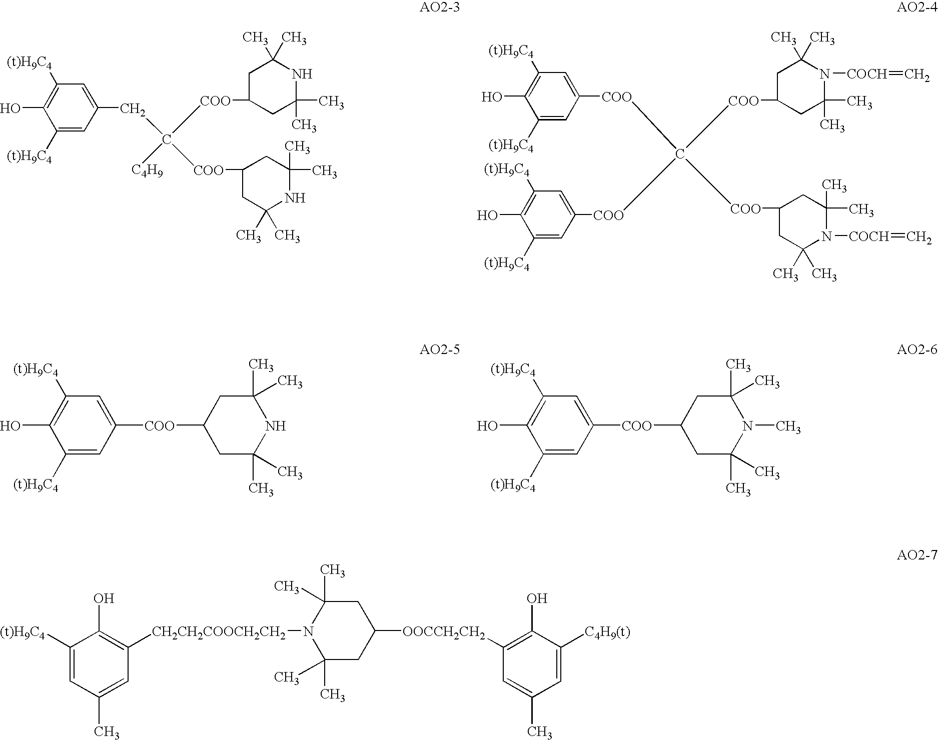

Examples of solvents or dispersants used for formation of an intermediate layer, a charge generation layer, a charge transport layer and the like include n-butylamine, diethylamine, ethylenediamine, isopropanolamine, triethanolamine, triethylene diamine, N,N-dimethylformaldehyde, acetone, methyl ethyl ketone, methyl isopropyl ketone, cyclohexane, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolan, dioxane, methanol, ethanol, butanol, isopropanol, ethyl acetate, butyl acetate, dimethylsulfoxide, and methyl cellosolve. These solvents may be used singly or in combination.

In the following, an image forming apparatus using the organic photoreceptor of the invention will be described.

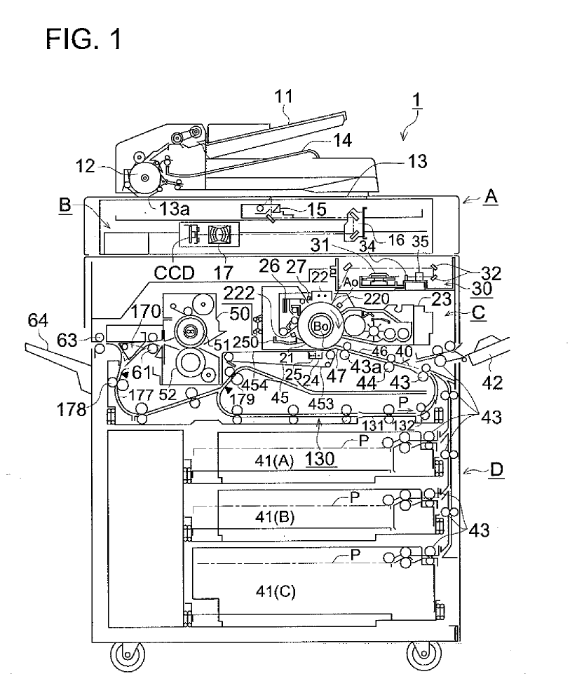

An image forming apparatus 1, as illustrated in FIG. 1, is a digital type image forming apparatus, which comprises an image reading section A, an image processing section B, an image forming section C and a transfer paper conveyance section D as a means for conveying transfer paper.

An automatic manuscript feeder to automatically convey a manuscript is provided above the image reading section. A manuscript placed on a manuscript-setting table 11 is conveyed sheet by sheet by a manuscript-conveying roller 12 and read at a reading position 13a to read images. A manuscript having finished manuscript reading is discharged onto a manuscript discharge tray 14 by the manuscript-conveying roller 12.

On the other hand, the image of a manuscript placed on a platen glass 13 is read by a reading action, at a rate of v, of a first mirror unit 15 constituted of a lighting lamp and a first mirror, followed by conveyance at a rate of v/2 toward a second mirror unit 16 constituted of a second mirror and a third mirror which are disposed in a V-form.

The thus read image is formed through a projection lens 17 onto the acceptance surface of an image sensor CCD as a line sensor. Aligned optical images formed on the image sensor CCD are sequentially photo-electrically converted to electric signals (luminance signals), then subjected A/D conversion and further subjected to treatments such as density conversion and a filtering treatment in the image processing section B, thereafter, the image data is temporarily stored in memory.

In the image forming section C, a drum-form photoreceptor 21 as an image bearing body and in its surrounding, a charger 22 (charging step) to allow the photoreceptor 21 to be charged, a potential sensor 220 to detect the surface potential of the charged photoreceptor, a developing device 23 (development step), a transfer conveyance belt device 45 as a transfer means (the transfer step), a cleaning device 26 (cleaning step) for the photoreceptor 21 and a pre-charge lamp (PCL) 27 as a photo-neutralizer (photo-neutralizing step) are disposed in the order to carry out the respective operations. A reflection density detector 222 to measure the reflection density of a patch image developed on the photoreceptor 21 is provided downstream from the developing means 23. The photoreceptor 21, which employs an organic photoreceptor relating to the invention, is rotatably driven clockwise, as indicated.

After having been uniformly charged by the charger 22, the rotating photoreceptor 21 is imagewise exposed through an exposure optical system as an imagewise exposure means 30 (imagewise exposure step), based on image signals called up from the memory of the image processing section B. The exposure optical system as an imagewise exposure means 30 of a writing means employs a laser diode, not shown in the drawing, as an emission light source and its light path is bent by a reflecting mirror 32 via a rotating polygon mirror 31, a fθ lens 34 and a cylindrical lens 35 to perform main scanning. Imagewise exposure is conducted at the position of Ao to the photoreceptor 21 and an electrostatic latent image is formed by rotation of the photoreceptor (sub-scanning). In one of the embodiments, the character portion is exposed to form an electrostatic latent image.

In the image forming apparatus of the invention, a semiconductor laser at a 350-800 nm oscillating wavelength or a light-emitting diode is preferably used as a light source for imagewise exposure. Using such a light source for imagewise exposure, an exposure dot diameter in the main scanning direction of writing can be narrowed to 10-100 μm and digital exposure can be performed onto an organic photoreceptor to realize an electrophotographic image exhibiting a high resolution of 400 to 2500 dpi (dpi: dot number per 2.54 cm). The exposure dot diameter refers to an exposure beam length (Ld, measured at the position of the maximum length) along the main-scanning direction in the region exhibiting an exposure beam intensity of not less than 1/e² of the peak intensity.

Utilized light beams include a scanning optical system using a semiconductor laser and a solid scanner of LED, while the light intensity distribution includes a Gaussian distribution and a Lorentz distribution, but the exposure dot diameter is defined as a region of not less than 1/e² of the respective peak intensities.

An electrostatic latent image on the photoreceptor 21 is reversely developed by the developing device 23 to form a visible toner image on the surface of the photoreceptor 21. In the image forming method of the invention, thea developer used in the developing device preferably is a polymerization toner. The combined use of a polymerization toner which is uniform in shape and particle size distribution and the organic photoreceptor of the invention can obtain electrophotographic images exhibiting superior sharpness.

In the transfer paper conveyance section D, paper supplying units 41(A), 41(B) and 41(C) as a transfer paper housing means for housing transfer paper P differing in size are provided below the image forming unit and a paper hand-feeding unit 42 is laterally provided, and transfer paper P chosen from either one of them is fed by a guide roller 43 along a conveyance route 40. After the fed paper P is temporarily stopped by paired paper feeding resist rollers 44 to make correction of tilt and bias of the transfer paper P, paper feeding is again started and the paper is guided to the conveyance route 40, a transfer pre-roller 43a, a paper feeding route 46 and entrance guide plate 47. A toner image on the photoreceptor 21 is transferred onto the transfer paper P at the position of Bo, while being conveyed with being put on a transfer conveyance belt 454 of a transfer conveyance belt device 45 by a transfer pole 24 and a separation pole 25. The transfer paper P is separated from the surface of the photoreceptor 21 and conveyed to a fixing device 50 by the transfer conveyance belt 45.

The fixing device 50 has a fixing roller 51 and a pressure roller 52 and allows the transfer paper P to pass between the fixing roller 51 and the pressure roller 52 to fix the toner by heating and pressure. The transfer paper P which has completed fixing of the toner image is discharged onto a paper discharge tray 64.

Image formation on one side of transfer paper is described above and in the case of two-sided copying, a paper discharge switching member 170 is switched over, and a transfer paper guide section 177 is opened and the transfer paper P is conveyed in the direction of the dashed arrow. Further, the transfer paper P is conveyed downward by a conveyance mechanism 178 and switched back in a transfer paper reverse section 179, and the rear end of the transfer paper P becomes the top portion and is conveyed to the inside of a paper feed unit 130 for two-sided copying.

The transfer paper P is moved along a conveyance guide 131 in the paper feeding direction, transfer paper P is again fed by a paper feed roller 132 and guided into the transfer route 40. The transfer paper P is again conveyed toward the direction of the photoreceptor 21 and a toner is transferred onto the back surface of the transfer paper P, fixed by the fixing device 50 and discharged onto the paper discharge tray 64.

In an image forming apparatus relating to the invention, constituent elements such as a photoreceptor, a developing device and a cleaning device may be integrated as a process cartridge and this unit may be freely detachable. At least one of an electrostatic charger, an image exposure device, a transfer or separation device and a cleaning device is integrated with a photoreceptor to form a process cartridge as a single detachable unit from the apparatus body and may be detachable by using a guide means such as rails in the apparatus body.

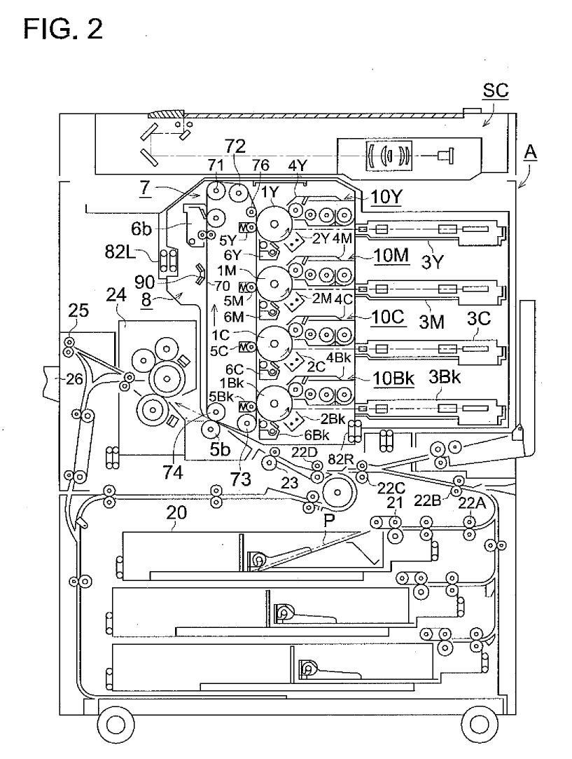

FIG. 2 illustrates a sectional view of a color image forming apparatus showing one of the embodiments of the invention.

This image forming apparatus is called a tandem color image forming apparatus, which is, as a main constitution, comprised of four image forming sections (image forming units) 10Y, 10M, 10C and 10Bk; an intermediate transfer material unit 7 of an endless belt form, a paper feeding and conveying means 21 and as a fixing means 24. Original image reading device SC is disposed in the upper section of image forming apparatus body A.

Image forming section 10Y to form a yellow image comprises a drum-form photoreceptor 1Y as the first photoreceptor; an electrostatic-charging means 2Y (electrostatic-charging step), an exposure means 3Y (exposure step), a developing means 4Y (developing step), a primary transfer roller 5Y (primary transfer step) as a primary transfer means; and a cleaning means 6Y, which are disposed around the photoreceptor 1Y.

An image forming section 10M to form a magenta image comprises a drum-form photoreceptor 1M as the second photoreceptor; an electrostatic-charging means 2M, an exposure means 3M and a developing means 4M, a primary transfer roller 5M as a primary transfer means; and a cleaning means 6M, which are disposed around the photoreceptor 1M.

An image forming section 10C to form a cyan image formed on the respective photoreceptors comprises a drum-form photoreceptor 1C as the third photoreceptor, an electrostatic-charging means 2Y, an exposure means 3C, a developing means 4C, a primary transfer roller 5C as a primary transfer means and a cleaning means 6C, all of which are disposed around the photoreceptor 1C.

An image forming section 10Bk to form a black image formed on the respective photoreceptors comprises a drum-form photoreceptor 1Bk as the fourth photoreceptor; an electrostatic-charging means 2Bk, an exposure means 3Bk, a developing means 4Bk, a primary transfer roller 5Bk as a primary transfer means and a cleaning means 6Bk, which are disposed around the photoreceptor 1Bk.

The foregoing four image forming units 10Y, 10M, 10C and 10Bk are comprised of centrally-located photoreceptor drums 1Y, 1M, 1C and 1Bk; rotating electrostatic-charging means 2Y, 2M, 2C and 2Bk; imagewise exposure means 3Y, 3M, 3C and 3Bk; rotating developing means 4Y, 4M, 4C and 4Bk; and cleaning means 5Y, 5M, 5C and 5Bk for cleaning the photoreceptor drums 1Y, 1M, 1C and 1Bk.

The image forming units 10Y, 10M, 10C and 10Bk are different in color of toner images formed in the respective photoreceptors 1Y, 1M, 1C and 1Bk but are the same in constitution, and, for example, the image forming unit 10Y will be described below.

The image forming unit 10Y disposes, around the photoreceptor 1Y, an electrostatic-charging means 2Y (hereinafter, also denoted as a charging means 2Y or a charger 2Y), an exposure means 3Y, developing means (developing step) 4Y, and a cleaning means 5Y (also denoted as a cleaning blade 5Y, and forming a yellow (Y) toner image on the photoreceptor 1Y. In this embodiment, of the image forming unit 10Y, at least the photoreceptor unit 1Y, the charging means 2Y, the developing means 4Y and the cleaning means 5Y are integrally provided.

The charging means 2Y is a means for providing a uniform electric potential onto the photoreceptor drum 1Y. In the embodiment, a corona discharge type charger 2Y is used for the photoreceptor 1Y.

The imagewise exposure means 3Y is a mean which exposes, based on (yellow) image signals, the photoreceptor drum 1Y having a uniform potential given by the charger 2Y to form an electrostatic latent image corresponding to the yellow image. As the exposure means 3Y is used one composed of an LED arranging emission elements arrayed in the axial direction of the photoreceptor drum 1Y and an imaging device (trade name: SELFOC Lens), or a laser optical system.

In the image forming apparatus relating to the invention, the above-described photoreceptor and constituting elements such as a developing device and a cleaning device may be integrally combined as a process cartridge (image forming unit), which may be freely detachable from the apparatus body. Further, at least one of a charger, an exposure device, a developing device, a transfer or separating device and a cleaning device is integrally supported together with a photoreceptor to form a process cartridge as a single image forming unit which is detachable from the apparatus body by using a guide means such as a rail of the apparatus body.

Intermediate transfer unit 7 of an endless belt form is turned by plural rollers and has intermediate transfer material 70 as the second image carrier of an endless belt form, while being pivotably supported.

The individual color images formed in image forming sections 10Y, 10M, 10C and 10Bk are successively transferred onto the moving intermediate transfer material (70) of an endless belt form by primary transfer rollers 5Y, 5M, 5C and 5Bk, respectively, to form a composite color image. Recording member P of paper or the like, as a final transfer material housed in a paper feed cassette 20, is fed by paper feed and a conveyance means 21 and conveyed to a secondary transfer roller 5b through plural intermediate rollers 22A, 22B, 22C and 22D and a resist roller 23, and color images are secondarily transferred together on the recording member P. The color image-transferred recording member (P) is fixed by a heat-roll type fixing device 24, nipped by a paper discharge roller 25 and put onto a paper discharge tray outside a machine. Herein, a transfer support of a toner image formed on the photoreceptor, such as an intermediate transfer body and a transfer material collectively means a transfer medium.

After a color image is transferred onto a transfer material P by a secondary transfer roller 5b as a secondary transfer means, an intermediate transfer material 70 of an endless belt form which separated the transfer material P removes any residual toner by cleaning means 6b.

During the image forming process, the primary transfer roller 5Bk is always in contact with the photoreceptor 1Bk. Other primary transfer rollers 5Y, 5M and 5C are each in contact with the respectively corresponding photoreceptors 1Y, 1M and 1C only when forming a color image.

The secondary transfer roller 5b is in contact with the intermediate transfer material 70 of an endless belt form only when the transfer material P passes through to perform secondary transfer

A housing 8, which can be pulled out from the apparatus body A through supporting rails 82L and 82R, is comprised of image forming sections 10Y, 10M, 10C and 10Bk and the endless belt intermediate transfer unit 7.

Image forming sections 10Y, 10M, 10C and 10Bk are aligned vertically. The endless belt intermediate transfer material unit 7 is disposed on the left side of photoreceptors 1Y, 1M, 1C and 1Bk, as indicated in FIG. 2. The intermediate transfer material unit 7 comprises the endless belt intermediate transfer material 70 which can be turned via rollers 71, 72, 73 and 74, primary transfer rollers 5Y, 5M, 5C and 5Bk and cleaning means 6b.

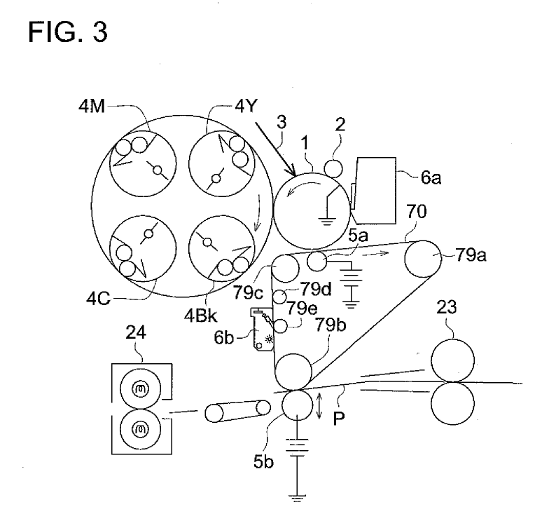

FIG. 3 illustrates a sectional view of a color image forming apparatus using an organic photoreceptor according to the invention (a copier or a laser beam printer which comprises, around the organic photoreceptor, an electrostatic-charging means, an exposure means, plural developing means, a transfer means, a cleaning means and an intermediate transfer means). The intermediate transfer material 70 of an endless belt form employs an elastomer of moderate resistance.

The numeral 1 designates a rotary drum type photoreceptor, which is repeatedly used as an image forming body, is rotatably driven anticlockwise, as indicated by the arrow, at a moderate circumferential speed.

The photoreceptor 1 is uniformly subjected to an electrostatic-charging treatment at a prescribed polarity and potential by a charging means 2 (charging step), while being rotated. Subsequently, the photoreceptor 1 is subjected to imagewise exposure via an imagewise exposure means 3 (imagewise exposure step) by using scanning exposure light of a laser beam modulated in correspondence to the time-series electric digital image signals of image data to form an electrostatic latent image corresponding to a yellow (Y) component image (color data) of the objective color image.

Subsequently, the electrostatic latent image is developed by a yellow toner of a first color in a yellow (Y) developing means 4Y: developing step (the yellow developing device). At that time, the individual developing devices of the second to fourth developing means 4M, 4C and 4Bk (magenta developing device, cyan developing device, black developing device) are in operation-off and do not act onto the photoreceptor 1 and the yellow toner image of the first color is not affected by the second to fourth developing devices.

The intermediate transfer material 70 is rotatably driven clockwise at the same circumferential speed as the photoreceptor 1, while being tightly tensioned onto rollers 79a, 79b, 79c, 79d and 79e.

The yellow toner image formed and borne on the photoreceptor 1 is successively transferred (primary-transferred) onto the outer circumferential surface of the intermediate transfer material 70 by an electric field formed by a primary transfer bias applied from a primary transfer roller 5a to the intermediate transfer material 70 in the course of being passed through the nip between the photoreceptor 1 and the intermediate transfer material 70.

The surface of the photoreceptor 1 which has completed transfer of the yellow toner image of the first color is cleaned by a cleaning device 6a.

In the following, a magenta toner image of the second color, a cyan toner image of the third color and a black toner image of the fourth color are successively transferred onto the intermediate transfer material 70 and superimposed to form superimposed color toner images corresponding to the intended color image.

A secondary transfer roller 5b, which is allowed to bear parallel to a secondary transfer opposed roller 79b, is disposed below the lower surface of the intermediate transfer material 70, while being kept in the state of being separable.

The primary transfer bias for transfer of the first to fourth successive color toner images from the photoreceptor 1 onto the intermediate transfer material 70 is at the reverse polarity of the toner and applied from a bias power source. The applied voltage is, for example, in the range of +100 V to +2 kV.

In the primary transfer step of the first through third toner images from the photoreceptor 1 to the intermediate transfer material 70, the secondary transfer roller 5b and the cleaning means 6b for the intermediate transfer material are each separable from the intermediate transfer material 70.

The superimposed color toner image which was transferred onto the intermediate transfer material 70 is transferred to a transfer material P as the second image bearing body in the following manner. Concurrently when the secondary transfer roller 5b is brought into contact with the belt of the intermediate transfer material 70, the transfer material P is fed at a prescribed timing from paired paper-feeding resist rollers 23, through a transfer paper guide, to the nip in contact with the belt of the intermediate transfer material 70 and the secondary transfer roller 5b. A secondary transfer bias is applied to the second transfer roller 5b from a bias power source. This secondary bias transfers (secondary-transfers) the superimposed color toner image from the intermediate transfer material 70 to the transfer material P as a secondary transfer material. The transfer material P having the transferred toner image is introduced to a fixing means 24 and is subjected to heat-fixing.

The image forming apparatus relating to the invention is not only suitably used for general electrophotographic apparatuses such as an electrophotographic copier, a laser printer, an LED printer and a liquid crystal shutter type printer, but is also broadly applicable to apparatuses employing electrophotographic technologies for a display, recording, shortrun printing, printing plate making, facsimiles and the like.

### EXAMPLES

The present invention will be further described with reference to examples but the embodiments of the invention are by no means limited to these. In the following examples, “part(s)” represents part(s) by mass unless otherwise noted

### Preparation of Photoreceptor 1

Photoreceptor 1 was prepared in the following manner.

### Intermediate Layer

The following intermediate layer coating solution was coated by an immersion coating method on a washed cylindrical aluminum substrate (which was machined to a ten-point surface roughness (Rz) of 0.81 μm, defined in JIS B-0601) and dried at 120° C. for 30 min. to form an intermediate layer 1 having a dry thickness of 5 μm.

### Preparation Of Intermediate Layer Coating Solution

An intermediate layer dispersion, as described below was diluted twice by the same solvent, allowed to stand for one day and night and filtered with a filter (Profile, produced by Nippon Paul Co., rated filtration accuracy of 5 μm, pressure: 50 kPa) to obtain intermediate layer coating solution.

Intermediate layer dispersion:

| | |
|---|---|
| Binder resin (exemplified polyamide N-1) | 1 parts |
| Rutile type Titanium oxide* | 5.6 parts |
| Ethanol/n-propyl alcohol/THF (45/20/30 | 10 parts |
| by mass) | |

*titanium oxide pigment having a primary particle size of 35 nm and surface-treated with dimethyl polysiloxane having a hydroxy group at the end position to have a hydrophobicity degree of 33

The foregoing composition was batch-wise mixed with a sand mill over 10 hrs. to prepare an intermediate layer coating solution.

Charge generation layer (CGL) coating solution:

| | |
|---|---|
| Charge generation material (CGM 2-18) | 24.0 parts |
| Polyvinyl butyral resin (BL-1 | 12.0 parts |
| produced by Sekisui Kagaku Co.) | |
| 2-Butanine/cyclohexanone mixture | 300 parts |
| (volume ratio: 4/1) | |

The foregoing coating solution was coated on the intermediate layer by a dip-coating method to form a charge generation layer of a dry thickness of 0.5 μm.

Charge transport layer (CTL) coating solution:

| | | |
|---|---|---|
| Charge transport material (CGM 1-6) | 214 | parts |
| Charge transport material (CGM 2-2) | 11 | parts |
| Polycarbonate (Z300, produced by | 300 | parts |
| Mitsubishi Gas Kagaku) | | |
| Antioxidant (AO-1) | 3 | parts |
| Tetrahydrofuran/toluene (4/1 by volume) | 2000 | parts |
| Silicone oil (KF-54, produced | 1 | part |
| by Shinetsu Kagaku) | | |

The foregoing composition was mixed and dissolved to prepare a charge transport layer coating solution. The coating solution was coated on the charge generation layer and dried at 110° C. for 70 min. to form a charge transport layer of a dry thickness of 20.0 μm. There was thus prepared photoreceptor 1.

### Preparation Of Photoreceptor 2-19

Photoreceptors 2-19 were prepared similarly to the foregoing photoreceptor 1, provided that the charge transport materials in the charge transport layer was replaced by charge transport materials shown in Table 1. CTM-R used in photoreceptor 19 is a charge transport material, as described below.

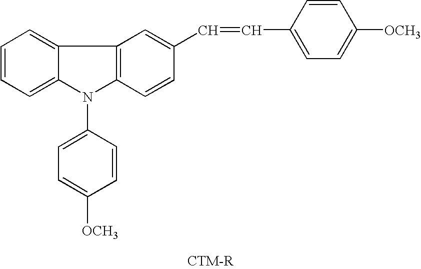

### Evaluation

The thus prepared photoreceptors and their intermediate materials were each evaluated as below with respect to coating solution stability of the charge transport layer, transmittance of the charge transport layer, sensitivity of the photoreceptor, electric potential stability, fine-line reproducibility and cracking.

### Coating Solution Stability

A coating solution of a charge transport layer was allowed to stand for one month at room temperature and the presence/absence of precipitates was visually observed and evaluated based on the following criteria:
A: no precipitates were observed,
C: precipitates were observed.

### Charge Transport Layer Transmittance

A charge transport layer, on transparent polyester film, was formed at a thickness which was the same as in the photoreceptor and the transmittance at 370 nm and 405 nm was measured by a UV visible spectrometer (V-530, produced by Nippon Bunko Co., Ltd.) at a scanning rate of 1,000 nm/min.

### Sensitivity

Digital copier Sitos 7085 (produced by Konica Minolta Business Technologies Inc.) basically having the constitution shown in FIG. 1 was modified, in which processing conditions were modified so that imagewise exposure was performed using a 405 nm semiconductor laser at a beam diameter of 30 μm and 1200 dpi as a light source and the surface potential of a photoreceptor was determined by a surface potentiometer). Using such a modified machine, each of the prepared photoreceptors was charged to a surface potential of −700 V and then exposed to light. The exposure amount necessary allow a surface potential to decay to −350 V was measured to determine sensitivity (E_{1/2}).

### Potential Stability

Effects due to exposure to external light was determined. Thus, the electric potential on an exposed area of a photoreceptor before or after being exposed to a fluorescent lamp at 1000 lux (denoted as Vi initial and Vi fatigued) was measured using the above-described modified machine.

### Fine-Line Reproducibility

Using the foregoing modified machine, images were formed under normal temperature and humidity (20° C., 55% RH) and evaluated with respect to fine-line reproducibility. Fine line portions were magnified using a 10fold magnifier, the number of fine lines per mm was visually counted and evaluated based on the following criteria:
A: 8 or more lines were observed,
B: 6-7 lines were observed,
C: 4-5 lines were observed
D: 3 or fewer lines were observed.

### Cracking

The foregoing modified machine was allowed to stand for 2 days under an environment of 30° C. and 80% RH, while the photoreceptors having been installed and an electric source being turned off. Members surrounding the photoreceptor were allowed to stop their actions, that is, members such as a cleaning blade and a developer conveying body were allowed to remain in contact with the photoreceptor. Thereafter, the photoreceptor surface was visually observed to examine occurrence of cracking. Image evaluation was also made to observe streak-like image defects occurring in conjunction with cracking. There were evaluated 100 photoreceptors, based on the following criteria:
A: neither cracks nor streak-like image defects were observed (excellent)
B: slightly cracking was observed but no streak-like image defect was observed (acceptable in practice)
C: occurrence of cracking and streak-like image defects was observed (unacceptable in practice).

Evaluation results are shown in Table 1.

TABLE 1

| | | | CTL | | | Potential | | | | | |
|---|---|---|---|---|---|---|---|---|---|---|---|
| Photo- | | | Transmittance | | | Stability (V) | | | Coating | | |
| receptor | CTM 1 | CTM 2 | (%) | | Sensitivity | Vi | Vi | Fine-line | Solution | | |
| No. | (part) | (part) | 370 nm | 405 nm | (E_{1/2}) | initial | fatigue | Reproducibility | Stability | Cracking | Remark |
| 1 | 1-6 (95) | 2-2 (5) | 5 | 97 | 0.16 | 75 | 80 | A | A | B | Inv. |
| 2 | 1-6 (90) | 2-2 (10) | 0 | 96 | 0.18 | 80 | 80 | B | A | B | Inv. |
| 3 | 1-6 (80) | 2-2 (20) | 0 | 93 | 0.22 | 90 | 90 | B | A | B | Inv. |
| 4 | 1-6 (95) | 2-4 (5) | 0 | 95 | 0.18 | 85 | 90 | B | A | B | Inv. |
| 5 | 1-6 (95) | 2-2 (5) | 2 | 96 | 0.17 | 80 | 80 | A | A | B | Inv. |
| 6 | 1-6 (95) | 2-2 (5) | 3 | 95 | 0.19 | 75 | 75 | B | A | B | Inv. |
| 7 | 1-6 (99) | 3-1 (1) | 8 | 97 | 0.17 | 80 | 95 | A | A | B | Inv. |
| 8 | 1-6 (95) | 3-1 (5) | 0 | 93 | 0.19 | 85 | 90 | A | A | B | Inv. |
| 9 | 1-6 (90) | 3-1 (10) | 0 | 88 | 0.22 | 95 | 95 | B | A | B | Inv. |
| 10 | 1-6 (95) | 3-3 (5) | 0 | 84 | 0.18 | 90 | 90 | B | A | B | Inv. |
| 11 | 1-6 (95) | 3-6 (5) | 0 | 79 | 0.24 | 105 | 105 | A | A | B | Inv. |
| 12 | 1-6 (95) | 4-1 (5) | 5 | 96 | 0.18 | 90 | 95 | A | A | B | Inv. |
| 13 | 1-6 (95) | 4-1 (5) | 4 | 96 | 0.21 | 100 | 110 | A | A | B | Inv. |
| 14 | 1-6 (95) | 3-1 (5) | 0 | 92 | 0.19 | 95 | 100 | A | A | B | Inv. |
| 15 | 1-6 (95) | 3-1 (5) | 0 | 94 | 0.21 | 100 | 105 | A | A | B | Inv. |
| 16 | 1-6 (100) | — | 54 | 97 | 0.16 | 65 | 250 | B | C | C | Comp. |
| 17 | 1-6 (99) | 2-2 (1) | 19 | 97 | 0.16 | 90 | 190 | B | A | C | Comp. |
| 18 | 1-6 (80) | 3-6 (20) | 0 | 42 | 0.36 | 180 | 185 | D | A | B | Comp. |
| 19 | 1-6 (95) | CTM-R (5) | 1 | 92 | 0.34 | 165 | 190 | D | A | B | Comp. |

As is apparent from Table 1, it was proved that photoreceptors of the invention exhibited enhanced sensitivity, improved electric-potential stability without causing deposition of a charge transport material in the process of production, and not causing cracking.

What is claimed is:

1. An electrophotographic photoreceptor comprising on an electrically conductive support, a charge generation layer and a charge transport layer, wherein the charge transport layer comprises a charge transport material represented by the following formula (1) and exhibits a transmittance at 370 nm of not more than 100% and a transmittance at 405 nm of not less than 70%, and the charge transport layer further comprising a compound represented by the following formula (2), (3) or (4): 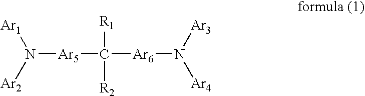
wherein Ar₁, Ar₂, Ar₃ and Ar₄ are each independently an unsubstituted or substituted aryl group, or Ar₁ and Ar₂ or Ar₃ and Ar₄ combine to form a ring; Ar₅ and A₆ are each independently an unsubstituted or substituted arylene group; R₁ and R₂ are each independently a hydrogen atom or an unsubstituted or substituted alkyl, aralkyl or aryl group, or R₁ and R₂ combine to form a ring; 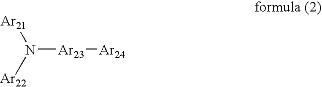
wherein Ar₂₁, A₂₂ and A₂₄ are each independently an unsubstituted or substituted aryl group; Ar₂₃ is an unsubstituted or substituted arylene group, or Ar₂₁ and Ar₂₂ or Ar₂₂ and Ar₂₄ combine to form a ring; 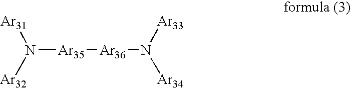
wherein Ar₃₁, Ar₃₂, Ar₃₃ and Ar₃₄ are each independently an unsubstituted or substituted aryl group, and Ar₃₅ and Ar₃₆ are each independently an unsubstituted or substituted arylene group, or Ar₃₁ and Ar₃₂, Ar₃₃ and Ar₃₄, or Ar₃₅ and Ar₃₆ combine to form a ring; 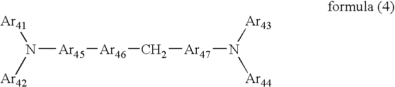
wherein Ar₄₁, Ar₄₂, A₄₃ and Ar₄₄ are each independently an unsubstituted or substituted aryl group, and Ar₄₅, A₄₆ and Ar₄₇ are each an unsubstituted or substituted arylene group, or Ar₄₁ and Ar₄₂ or Ar₄₃ and Ar₄₄ combine with each other to form a ring.

2. The electrophotographic photoreceptor of claim 1, wherein in the formula (1), Ar₁, Ar₂, Ar₃ and Ar₄ are each independently an unsubstituted or substituted phenyl group.

3. The electrophotographic photoreceptor of claim 1, wherein in the formula (1), Ar₅ and Ar₆ are each independently an unsubstituted or substituted phenylene group.

4. The electrophotographic photoreceptor of claim 1, wherein in the formula (1), Ar₁ and Ar₂ or Ar₃ and Ar₄ combine to form a 5- or 6-membered heterocyclic ring.

5. The electrophotographic photoreceptor of claim 1, wherein in the formula (1), R₁ and R₂ each is any one selected from the group consisting of an unsubstituted or substituted alkyl, benzyl and phenyl groups.

6. The electrophotographic photoreceptor of claim 1, wherein in the formula (1), R₁ and R₂ combine to form a saturated hydrocarbon ring having 4 to 8 carbon.

7. The electrophotographic photoreceptor of claim 1, wherein in the formula (1), R₁ and R₂ combine to form a cyclohexane ring.

8. The electrophotographic photoreceptor of claim 1, wherein in the formula (1), at least one of Ar₁, Ar₂, Ar₃, Ar₄, Ar₅, Ar₆, R₁ and R₂ is substituted by an alkyl or alkoxy group having 1 to 4 carbon atoms.

9. The electrophotographic photoreceptor of claim 1, wherein an intermediate layer containing a binder resin and N-type semiconductor particles is provided between the electrically conductive support and the charge generation layer or between the charge generation layer and the charge transport layer.

10. The electrophotographic photoreceptor of claim 9, wherein the N-type semiconductor is a titanium oxide.

11. The electrophotographic photoreceptor of claim 9 wherein the binder resin is an alcohol-soluble polyamide resin.

12. The electrophotographic photoreceptor of claim 1, wherein the charge generation layer comprises a charge transport material and the charge generation material is a polycyclic quinone compound.

13. The electrophotographic photoreceptor of claim 1, wherein the charge transport layer further comprises a polycarbonate resin.

14. An image forming method comprising the steps of:
subjecting an electrophotographic photoreceptor to imagewise exposure by use of a writing light source of a semiconductor laser exhibiting an emission wavelength of 380 to 500 nm or a light-emitting diode exhibiting a peak wavelength of 380 to 500 nm to form an electrostatic latent image, and
developing the electrostatic latent image to form a toner image,
wherein the electrophotographic photoreceptor comprises on an electrically conductive support, a charge generation layer and a charge transport layer, wherein the charge transport layer comprises a charge transport material represented by the following formula (1) and the charge transport layer exhibits a transmittance at 370 nm of not more than 10% and a transmtittance at 405 nm of not less than 70%, and the charge transport layer further comprising a compound represented by the following formula (2), (3) or (4): 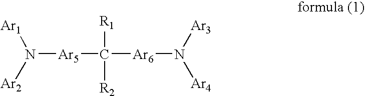
wherein Ar₁, Ar₂, Ar₃ and Ar₄ are each independently an unsubstituted or substituted aryl group, or Ar₁ and Ar₂ or Ar₃ and Ar₄ combine to form a ring; Ar₅ and A₆ are each independently an unsubstituted or substituted arylene group; R₁ and R₂ are each independently a hydrogen atom or an unsubstituted or substituted alkyl, aralkyl or aryl group, or R₁ and R₂ combine to form a ring; 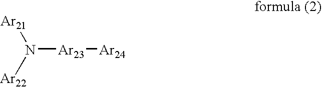
wherein Ar₂₁, A₂₂ and A₂₄ are each independently an unsubstituted or substituted aryl group; Ar₂₃ is an unsubstituted or substituted arylene group, or Ar₂₁ and Ar₂₂ or Ar₂₃ and Ar₂₄ combine to form a ring; 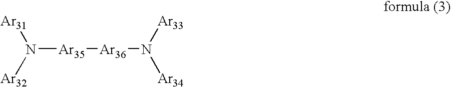
wherein Ar₃₁, Ar₃₂, Ar₃₃ and Ar₃₄ are each independently an unsubstituted or substituted aryl group, and Ar₃₅ and Ar₃₆ are each independently an unsubstituted or substituted arylene group, or Ar₃₁ and Ar₃₂, Ar₃₃ and Ar₃₄, or Ar₃₃ and Ar₃₆ combine to form a ring; 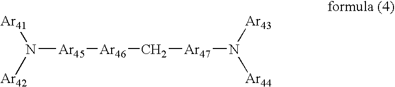
wherein Ar₄₁, Ar₄₂, A₄₃ and Ar₄₄ are each independently an unsubstituted or substituted aryl group, and Ar₄₅, Ar₄₆ and Ar₄₇ are each an unsubstituted or substituted arylene group, or Ar₄₁ and Ar₄₂ or A₄₃ and Ar₄₄ combine with each other to form a ring.
